(19) United States
(12) Patent Application Publication
(10) Pub. No.: US 2017/0294238 A1
(43) Pub. Date: Oct. 12, 2017

(54) NEUTRON SOURCE BASED ON A COUNTER-BALANCING PLASMA BEAM CONFIGURATION

(71) Applicant: Xian-Jun ZHENG, Mississauga (CA)

(72) Inventor: Xian-Jun ZHENG, Mississauga (CA)

(21) Appl. No.: 15/516,046

(22) PCT Filed: Oct. 1, 2015
(86) PCT No.: PCT/CA2015/050987

§ 371 Date: Mar. 31, 2017

Related U.S. Application Data
(60) Provisional application No. 62/058,425, filed on Oct. 1, 2014.

(51) Int. Cl. G21B 1/01; G21B 1/23; G21G 4/02; G21B 1/15

(52) U.S. Cl. CPC G21B 1/01; G21B 1/15; G21B 1/23; G21G 4/02

(57) ABSTRACT

A system for generating a source of neutrons from a thermonuclear fusion reaction includes a reaction chamber and a number of particle beam emitters. The reaction system has at least four particle beam emitters supported spatially around oriented toward a common focal region of the reaction chamber for directing the plurality of plasma beams that are spatially symmetrical in three dimensional space. Each of the plasma beams are directed towards a plasma region in the geometric center. A stable collapse of the plasma region permits a controllable and sufficiently long confinement time, which in combination with necessary temperature and density conditions may ignite and sustain fusion reactions and achieve a net energy output. Optionally, laser beams or other input energy devices may also be oriented around and toward the common focal region to direct high-energy laser beams at the plasma ball to assist with instigation of the fusion reaction. The thermonuclear reaction system may be used as a neutron source for nuclear power reactors.

### FIELD

The described embodiments relate to applied physics and, more particularly, to a system and method for providing a neutron source based on a counter-balancing plasma beam configuration.

### INTRODUCTION

Any device that emits neutrons, irrespective of the mechanism used to produce the neutrons, may be characterized as a neutron source. Neutron source devices are used in physics, engineering, medicine, nuclear weapons, petroleum exploration, biology, chemistry and nuclear power.

In one kind of fusion reaction that naturally occurs in many stars, such as the sun, two light atomic nuclei fuse together to form a heavier nucleus and, in doing so, release a large amount of energy. Fusion power may be generated from reactions using deuterium from water as fuel, without the need to use radioactive tritium as fuel.

### SUMMARY

The following introduction is provided to introduce the reader to the more detailed discussion to follow. The introduction is not intended to limit or define any claimed or as yet unclaimed invention. One or more inventions may reside in any combination or sub-combination of the elements or process steps disclosed in any part of this document including its claims and figures.

It is well understood that neutrons may be generated from fusion reactions using Deuterium (D) from water as fuel, with or without the use of radioactive tritium (T). The high-energy neutrons from deuterium-deuterium (D-D) fusion reactions or deuterium-tritium fusion (D-T) reactions can be used to directly split heavy nuclei for nuclear fission power in a hybrid fusion/fission reactor system. Alternatively, fusion neutrons may be moderated and then used to transmute fertile nuclear material, Uranium-238 or Thorium-232, into fissile nuclear material Plutonium-239 or Uranium-233, respectively. Plutonium-239 and Uranium-233 can be used subsequently in a pure fission reactor or hybrid fusion/fission reactor system.

It may be easier to achieve a positive net energy output from a hybrid fusion/fission reactor than from a pure fusion reactor. For example, one D-D fusion reaction can generate an average energy of 3.65 MeV and has 50% probability to produce a fusion neutron. This neutron can subsequently convert a Uranium-238 nucleus into a Plutonium-239 nucleus to release a total energy of 200 MeV through nuclear fission. In this simple hybrid fusion/fission approach, a break-even in fusion power can comfortably lead to net nuclear energy output (i.e., 200 MeV>2×3.65 MeV). Uranium-238 constitutes over 90% of the nuclear waste produced by the operating nuclear power plants world-wide. Thorium is estimated to be 3 to 4 times more abundant than uranium in the Earth's crust. It should be understood that these numbers are illustrative only.

### Fusion Reaction Rate

As presently understood, fusion reactions are achieved by bringing two or more nuclei close enough to one another that their residual strong force (i.e., nuclear force) will act to pull the two or more nuclei together and form one larger nucleus. When two “light” nuclei fuse, the usual result is the formation of a single nucleus having a slightly smaller mass than the sum of the masses of the original two nuclei. In this case, the difference in mass between the single fused nucleus and the original two nuclei is released as energy according to the well-known mass-energy equivalence formula:

E=mc² (1)

However, if two “heavy” nuclei of sufficient mass fuse together, the mass of the resulting single nucleus may be greater than the sum of the reactants' original masses. In this case, according to equation (1), a net input of energy from an external source will be required to drive such fusion reasons. Generally speaking, the dividing line between “light” and “heavy” nuclei is iron-56. Above this atomic mass, energy will generally be released by nuclear fission reactions; below it, by fusion.

The fusion of two nuclei is generally opposed by the repulsive electrostatic force created between the shared electrical charges of the two nuclei, specifically the net positive charge of the protons contained in the nuclei. To overcome this electrostatic force (referred to sometimes as a “Coulomb barrier”), some external source of energy is generally required. One way to provide an external source of energy is to heat the reactant atoms. This approach also has the additional benefit of stripping the atoms of electrons leaving the atoms as bare nuclei. Typically, the nuclei and electrons are formed into plasma.

As the temperature required to provide the nuclei with enough energy to overcome the repulsive electrostatic force varies as a function of the total charge, hydrogen, the atom having the smallest nuclear charge, tends to react at the lowest temperatures. Helium also has an extremely low mass per nucleon and is therefore also energetically favourable as a potential fusion product. Consequently, most fusion reactions are based on combining isotopes of hydrogen (protium, deuterium, or tritium) to form isotopes of helium, such as ³He or ⁴He.

Reaction cross section, denoted a, is a measure of the probability of a fusion reaction as a function of the relative velocity of the two reactant nuclei. If the reactant nuclei have a distribution of velocities, as would be expected for a thermal distribution within plasma, then an average over the distributions of the product of cross section and velocity may be performed. Reaction rate, in terms of fusion per volume per unit of time, may then be defined as [symbol] σv [symbol] times the product of the number density of reactant atoms. Accordingly, the reaction rate may equal:

f=(1/2n)² [symbol] σv [symbol] (2a)

for one reactant, where n represents the number density of atoms of the single reactant, and:

f=n₁n₂ [symbol] σv [symbol] (2b)

for two different reactants, where n₁ represents the number density of atoms of a first reactant and n₂ represents the number density of atoms of a second reactant distinct from the first reactant. For fusion reactions that also generate neutrons, the corresponding neutron release rate may be expressed simply as

fₙₑᵤₜᵣₒₙ=Nₙₑᵤₜᵣₒₙ×f (2c)

where Nₙₑᵤₜᵣₒₙ is the number of neutrons generated on average per each fusion reaction.

The product [symbol] σv [symbol] increases from near zero at room temperatures up to significant magnitudes at temperatures in the range of 10-100 keV (2.2-22 fJ). For similar plasma densities, D-T fusion tends to benefit from the lowest ignition temperature. Other possible fusions cycles include the proton-proton (p-p) fusion cycle, which provides the primary fusion power for stars like the Sun, the D-D fusion cycle, the proton-boron (p-¹¹B), the deuterium-helium (D-³He), and the helium-helium (³He-³He) cycle. However, these other fusion cycles typically require larger ignition energies and, in some cases, depend on ³He (which is relatively scarce on Earth).

### Deuterium-Tritium Fuel Cycle

One nuclear reaction presently used in fusion power is the deuterium-tritium fuel cycle, which may be expressed as:

₁²D+₁³T→₂⁴He+₀¹n+17.6 MeV (3)

where ₁²D represents a deuterium atom, ₁³T represents a tritium atom, ₂⁴He represents a helium atom (3.5 MeV), and ₀¹n represents a free neutron (14.1 MeV). Deuterium (also referred to as “Hydrogen-2”) is a naturally occurring isotope of hydrogen and, as such, is universally available. Tritium (also referred to as “Hydrogen-3”) is another isotope of hydrogen, but occurs naturally in small or negligible amounts due to its relatively brief radioactive half-life of approximately 12.32 years. Consequently, the deuterium-tritium fuel cycle requires synthesis of an ample supply of tritium atoms to be used in the fusion reaction. Two possible reactions to synthesize tritium from atoms of lithium include:

₀¹n+₃⁶Li→₁³T+₂⁴He (4)

or alternatively:

₀¹n+₃⁷Li→₁³T+₂⁴He+₀¹n (5)

The ⁶Li reaction is exothermic, providing a small energy gain for the reactor in the form of the released heat. On the other hand, the ⁷Li reaction is endothermic, thereby requiring energy, but does not consume the reactant neutron. At least some ⁷Li reactions may be used to replace neutrons lost due to reactions with other elements. In either lithium reaction, the reactant neutron may be supplied by the D-T fusion reaction shown above in equation (3). Most reactor designs take advantage of the naturally occurring mix of ⁶Li and ⁷Li lithium isotopes.

Several limitations are commonly associated with the D-T fuel cycle. For example, the D-T fuel cycle tends to produce substantial amounts of neutrons that induce radioactivity within the reactor structure and impose significant constraints on material design. Only about 20% of the fusion energy yield appears in the form of charged particles with the rest of the fusion energy being provided as neutron, which tends to limit the extent to which direct energy conversion techniques might be applied. The use of D-T fusion power also depends on available lithium resources, which are less abundant than deuterium resources and in growing demand due to increased production of Lithium based batteries and other related technologies. Yet another limitation of the D-T fuel cycle is that it requires handling of the radioisotope tritium. Similar to hydrogen, tritium may be difficult to contain and may leak from reactors in some quantity.

### Deuterium-Deuterium Fuel Cycle

There are two known branches of D-D fusion reactions (each with 50% probability of occurrence). The first branch produces a helium-3 nucleus (0.82 MeV) and a free neutron (2.45 MeV), i.e.

₁²D+₁²D→₂³He+₀¹n+3.27 MeV (6)

and the second branch produces a tritium (1.01 MeV) and a proton (3.02 MeV), i.e.,

₁²D+₁²D→₁³T+₁¹p+4.03 MeV (7)

where ₁¹p represents a proton and ₁³T can further react with ₁²D to produce a 14.1 MeV neutron, as in equation (3). Considering equations (6) and (7), a total of four deuterons can produce a total energy of 7.3 MeV and release a neutron with 2.45 MeV energy. The average energy release for a D-D fusion (two deuterons) is 3.65 MeV.

Helium-3 generated from the first branch of D-D reactions, equation (6), can be subsequently used for the following fusion reactions without neutron emissions,

₁²D+₂³He→₂⁴He+₁¹p+18.35 MeV (8)

Since the two reactants, i.e., deuterium and helium-3, need to be mixed together to fuse, reactions between nuclei of the same reactant will occur, and the one branch of D-D reactions described in equation (6) does produce a neutron.

Alternatively, helium-3 can fuse with itself according to

₂³He+₂³He→₂⁴He+₁¹H+₁¹H+12.86 MeV (9)

in clean fusion reactions. In this case, no neutrons would be produced and the fusion products are entirely charged particles, i.e., protons and helium-4, which can be contained within electro-magnetic fields. Such reactions may require higher temperatures for fusion since both reactants (helium-3) have two positive charges associated with a higher Coulomb barrier.

### Proton-Proton Chain Reaction Occurring Within Stars

As an alternative to the D-T fuel cycle, the proton-proton chain reaction is a naturally occurring process within stars of approximately the same size as the Sun or smaller. The proton-proton chain reaction is one of several fusion reactions by which stars of equal or lesser size as the Sun convert hydrogen to helium. However, unlike the D-T-fuel cycle, the proton-proton chain reaction does not induce radioactivity through neutron production.

In general, proton-proton fusion will occur when the temperature (i.e., kinetic energy) of the reactant protons is high enough to overcome their mutual electrostatic or Coulomb repulsion. While it is now accepted that proton-proton chain reactions are the dominant thermonuclear reactions fueling the sun and other stars, originally the temperature of the sun was thought to be too low to overcome the Coulomb barrier. However, through the discovery and development of quantum mechanics, it is now postulated that tunneling of the reactant protons through the repulsive electrostatic barrier allows for the proton-proton chain reaction to occur at lower temperatures than the classical prediction permitted.

The first of multiple steps in the proton-proton chain reaction involves the fusion of two protons into deuterium, in the process releasing a positron, a neutrino and energy, as one of the reactant protons beta decays into a neutron. This step of the proton-proton chain reaction may be expressed as:

₁¹H+₁¹H→₁²D+e⁺+vₑ+0.42 MeV (10)

where each ₁¹H represents a proton, ₁²D represents a product deuterium atom, e⁺ represents a positron, and vₑ represents a neutrino. This first step of the proton-proton chain is extremely slow, not just because the protons have to quantum tunnel through their Coulomb barrier, but also because the step depends on weak atomic interactions. To illustrate the speed of the reaction, deuterium-producing events are rare enough in the sun that a complete conversion of its hydrogen would take more than 10¹⁰ (ten billion) years given the prevailing conditions of the sun core. The fact that the sun is still shining is due to the slow nature of this reaction; if the reaction went faster, it is theorized that the Sun would have exhausted its hydrogen long ago.

In the next step of the proton-proton chain reaction, the positron is very quickly annihilated by an electron and the combined mass energy of the positron and electron is converted into two gamma rays and energy according to:

e⁺+e⁻→2γ+1.02 MeV (11)

where each γ represents a gammy ray. Subsequently, the deuterium atom produced in the first step of the proton-proton chain reaction fuses with another proton to produce a light isotope of helium, namely ³He, a further gamma ray and energy according to:

₁²D+₁¹H→₂³He+γ+5.49 MeV (12)

For temperatures in the range of about 10-14 MK (mega-kelvins), in the final step of the proton-proton chain reaction, two of the light isotopes of helium fuse together to form a ⁴He isotope, two protons and energy according to:

₂³He+₂³He→₂⁴He+₁¹H+₁¹H+12.86 MeV (13)

Combining the reaction steps expressed in equations (12) and (13) and canceling intermediate products, yields the overall proton-proton reaction given by:

₁²D+₁²D→₂⁴He+2γ+23.84 MeV (14)

In the Sun, the fusion path expressed in Equation (14) occurs with about 86% frequency with the remaining 14% due to other fusion reactions that prevail at temperatures exceeding 14 MK.

Satisfactory conditions of plasma velocity, temperature and density necessary to initiate fusion have been achieved in various research facilities. However, attempts to achieve fusion with a net energy output have so far been unsuccessful. It is thought that one reason for the lack of success is that confinement time has not been sufficient due to plasma instabilities.

Here, we propose that plasma instabilities may be suppressed in the spherical focal region of a counter-balancing beam configuration (e.g. a configuration of four plasma beams symmetrical in space) according to the minimization principle of potential energy. It is thought that a similar principle also ensures the stability of stars in astrophysics where nuclear fusion reactions occur. Confirmation tests as described herein may be carried out using wires containing or encapsulating deuterium. If successful, the test results may lead to a feasible approach to achieve a sustainable and possibly compact fusion neutron source using deuterium from water, with or without the use of radioactive tritium. The test results may also lead to a feasible approach to achieve commercial fusion power from water without the use of expensive and radioactive tritium as fuel.

In one broad aspect, there is provided a system for generating a source of neutrons from a thermonuclear reaction, the system comprising: a reaction chamber; a plurality of particle beam emitters supported spatially around the reaction chamber and oriented toward a common focal region of the reaction chamber for directing energized particles of at least one thermonuclear fuel type from the particle beam emitters as a plurality of particle beams converging at and penetrating through the common focal region to instigate the thermonuclear reaction that generates fusion neutrons, the plurality of particle beams being linear, counter-balancing, in plasma state, and under Z-pinch conditions; a plurality of particle beam receivers supported spatially around and oriented toward the common focal region, each particle beam receiver being located opposite a corresponding one of the plurality of particle beam emitters; and at least one voltage source operatively coupled to each particle beam emitter and its corresponding particle beam receiver for generating an electrical current through each particle beam in a closed electric loop running through the plasma beam and the common focal region.

In some embodiments, the generated electrical current through at least one of the plurality of particle beams is sufficient to accelerate electrons in the at least one of the plurality of particle beams to sufficiently large velocities in the applied electric field, and wherein the electrons in turn attract oppositely charged nuclei to achieve large velocities that become very high temperatures due to particle collision and penetration at the common focal region to initiate and sustain thermal nuclear reactions.

In some embodiments, the thermonuclear reaction system further comprises at least one pair of particle beam tubes, wherein the at least one pair of particle beam tubes comprises at least one of the plurality of particle beam emitters and at least one of the plurality of particle beam receivers, and the at least one of the plurality of particle beam emitters comprises a first end portion in fluid communication with a supply of the at least one thermonuclear fuel type and a second end portion in fluid communication with the reaction chamber for emitting the plurality of particle beams into the reaction chamber.

In some embodiments, the at least one of a plurality of particle beam receivers comprises a first end portion in fluid communication with the reaction chamber and a second end portion in fluid communication with a closed loop fluid circulation that connects to the corresponding particle beam tube emitter of the pair of particle beam tubes.

In some embodiments, the thermonuclear reaction system further comprises a plurality of electromagnetic coils aligned axially with and supported exterior to and in close proximity surrounding a particle beam tube of each of the plurality of particle beam emitters along at least a portion of the particle beam tubes, the plurality of electromagnetic coils for generating an axial magnetic field within the particle beam tubes to provide axial confinement of the energized particles in the high-energy plasma state within the particle beam tubes.

In some embodiments, the at least one voltage source is configured to supply a sufficiently high initial voltage to electrify particles of the at least one thermonuclear fuel type in the at least one pair of particle beam tubes.

In some embodiments, the at least one voltage source is configured to subsequently reduce the initial voltage to a minimum maintenance voltage in order to supply a desired level of electrical current running through the plasma beam.

In some embodiments, the particles of the at least one thermonuclear fuel type are initially at a relatively low temperature in at least one of the plurality of particle beam emitters, as the fuel particles enter into the at least one of the plurality of particle beam emitters, and wherein the particles of the at least one thermonuclear fuel type are turned into plasma in the form of a lightning beam due to Joule heating by the generated electrical current.

In some embodiments, the at least one voltage source is configured to generate at least one sufficiently large DC, AC, or pulse current capable of pinching each of the plurality of particle beams into a continuous or quasi-continuous lightning beam, whereby a hot and dense plasma core forms inside the common focal region due to radial collapse under electro-magnetic fields, the core being capable of sustaining stable and continuous or quasi-continuous fusion reactions.

In some embodiments, the at least one voltage source is configured to generate a plurality of sufficiently large AC or pulse currents arranged to generate shock waves directed towards the common focal region to maximize an energy concentration at the common focal region.

In some embodiments, the pulse current comprises electric pulses having a time duration in the order of micro-seconds, the electric pulses being separated by time periods in the order of milli-seconds and a minimum maintenance electrical current may or may not be provided during the time period between electric pulses.

In some embodiments, the thermonuclear reaction system further comprises at least some heavy water (D₂O) and impurity, such as sodium chloride (NaCl), to improve electric conductivity, reduce the initial voltage, and reduce the minimum maintenance voltage, and wherein the at least one thermonuclear fuel type comprises heavy water.

In some embodiments, the thermonuclear reaction system further comprises a gas separation tank fluidly coupled to the reaction chamber and the closed loop fluid circulation, the gas separation tank being configured to separate gaseous fusion products from unburned thermonuclear fuel particles extracted from the reaction chamber, wherein the closed loop fluid circulation is configured to transport the unburned thermonuclear fuel particles back to the reaction chamber.

In some embodiments, the thermonuclear reaction system further comprises a plurality of hollow starter inductors configured to establish initial boundary conditions for the formation of the plurality of particle beams.

In some embodiments, the at least one voltage source is configured to apply a voltage to the plurality of hollow starter inductors, and wherein the plurality of hollow starter inductors are configured to melt and/or vaporize due to Joule heating, starting from the common focal region, whereby the plurality of particle beams rapidly become electrically conducting lightning beams that collide and penetrate each other at the common focal region.

In some embodiments, the thermonuclear reaction system further comprises a plurality of ignition lasers supported spatially around and optically coupled with the reaction chamber, each of the plurality of ignition lasers oriented toward the common focal region to generate and emit a plurality of laser beams converging at the common focal region with the plurality of particle beams for assisting instigation of the thermonuclear reaction.

In some embodiments, the at least one thermonuclear fuel type comprises an isotope of Hydrogen.

In some embodiments, the at least one thermonuclear fuel type further comprises a mixture of two isotopes of Hydrogen.

In some embodiments, the plurality of particle beams being counter-balancing comprises at least three particle beams.

In some embodiments, the plurality of particle beam emitters comprises at least four particle beam emitters configured with spatial symmetry in terms of geometry and electromagnetic field.

In another broad aspect, there is provided a method of generating a source of neutrons from a thermonuclear reaction, the method comprising:

providing at least one thermonuclear fuel type; energizing a supply of the at least one thermonuclear fuel type to provide energized particles of the at least one thermonuclear fuel type in the form of plasma beam under Z-pinch conditions; accelerating the energized particles of the at least one thermonuclear fuel type into a reaction chamber as a plurality of particle beams converging toward and penetrating through a common focal region of the reaction chamber to instigate and sustain the thermonuclear reaction that generates fusion neutrons, the plurality of particle beams being linear and counter-balancing; and generating an electrical current flowing through each of the plurality of particle beams to provide radial confinement and axial acceleration of the energized particles of the at least one thermonuclear fuel type.

In some embodiments, the generated electrical current through at least one of the plurality of particle beams is sufficient to accelerate electrons in the at least one of the plurality of particle beams to sufficiently large velocities in the applied electric field, and wherein the electrons in turn attract oppositely charged nuclei to achieve large velocities that become very high temperatures due to particle collision and penetration at the common focal region to initiate and sustain thermal nuclear reactions.

In some embodiments, the method further comprises providing at least one pair of particle beam tubes, wherein the at least one pair of particle beam tubes comprises at least one of a plurality of particle beam emitters and at least one of a plurality of particle beam receivers, and the at least one of the plurality of particle beam emitters comprises a first end portion in fluid communication with a supply of the at least one thermonuclear fuel type and a second end portion in fluid communication with the reaction chamber for emitting the plurality of particle beams into the reaction chamber.

In some embodiments, the at least one of the plurality of particle beam receivers comprises a first end portion in fluid communication with the reaction chamber and a second end portion in fluid communication with a closed loop fluid circulation that connects to the corresponding particle beam tube emitter of the pair of particle beam tubes.

In some embodiments, the method further comprises providing a plurality of electromagnetic coils aligned axially with and supported exterior to and in close proximity surrounding a particle beam tube of each of the plurality of particle beam emitters along at least a portion of the particle beam tubes, and generating an axial magnetic field within the particle beam tubes to provide axial confinement of the energized particles in the high-energy plasma state within the particle beam tubes.

In some embodiments, energizing the supply of the at least one thermonuclear fuel type comprises applying a sufficiently high initial voltage to electrify particles of the at least one thermonuclear fuel type in the at least one pair of particle beam tubes.

In some embodiments, the method further comprises subsequently reducing the initial voltage to a minimum maintenance voltage in order to supply a desired level of electrical current running through the plasma beam.

In some embodiments, the particles of the at least one thermonuclear fuel type are initially at a relatively low temperature in at least one of the plurality of particle beam emitters, as the fuel particles enter into the at least one of the plurality of particle beam emitters, and wherein the particles of the at least one thermonuclear fuel type are turned into plasma in the form of a lightning beam due to Joule heating by the generated electrical current.

In some embodiments, generating the electrical current flowing through each of the plurality of particle beams comprises generating at least one sufficiently large DC, AC, or pulse current capable of pinching each of the plurality of particle beams into a continuous or quasi-continuous lightning beam, whereby a hot and dense plasma core forms inside the common focal region due to radial collapse under electro-magnetic fields, the core being capable of sustaining stable and continuous or quasi-continuous fusion reactions.

In some embodiments, generating the electrical current flowing through each of the plurality of particle beams comprises generating a plurality of sufficiently large AC or pulse currents arranged to generate shock waves directed towards the common focal region to maximize an energy concentration at the common focal region.

In some embodiments, the pulse current comprises electric pulses having a time duration in the order of micro-seconds, the electric pulses being separated by time periods in the order of milli-seconds and a minimum maintenance electrical current may or may not be provided during the time period between electric pulses.

In some embodiments, the method further comprises providing at least some heavy water (D₂O) and impurity, such as sodium chloride (NaCl), to improve electric conductivity, reduce the initial voltage , and reduce the minimum maintenance voltage, and wherein the at least one thermonuclear fuel type comprises heavy water.

In some embodiments, the method further comprises providing a gas separation tank fluidly coupled to the reaction chamber and the closed loop fluid circulation; separating gaseous fusion products from unburned thermonuclear fuel particles extracted from the reaction chamber, and transporting the unburned thermonuclear fuel particles back to the reaction chamber.

In some embodiments, the method further comprises providing a plurality of hollow starter inductors configured to establish initial boundary conditions for the formation of the plurality of particle beams, and applying a voltage to the plurality of hollow starter inductors, wherein the plurality of hollow starter inductors are configured to melt and/or vaporize due to Joule heating, starting from the common focal region, and whereby the plurality of particle beams rapidly become electrically conducting lightning beams that collide and penetrate each other at the common focal region.

In some embodiments, the method further comprises providing a plurality of ignition lasers supported spatially around and optically coupled with the reaction chamber, each of the plurality of ignition lasers oriented toward the common focal region; and generating and emitting a plurality of laser beams converging at the common focal region with the plurality of particle beams for assisting instigation of the thermonuclear reaction.

In some embodiments, the at least one thermonuclear fuel type comprises an isotope of Hydrogen.

In some embodiments, the at least one thermonuclear fuel type further comprises a mixture of two isotopes of Hydrogen.

In some embodiments, the plurality of particle beams being counter-balancing comprises at least three particle beams.

In some embodiments, the plurality of particle beam emitters comprises at least four particle beam emitters configured with spatial symmetry in terms of geometry and electromagnetic field.

These and other aspects and features of various embodiments will be described in greater detail below.

### BRIEF DESCRIPTION OF THE DRAWINGS

A detailed description of various embodiments is provided herein below with reference to the following drawings, by way of example only, and in which:

FIG. 1 is a schematic view of a thermonuclear reaction system;

FIG. 2 is a schematic view of an exemplary particle beam emitter;

FIG. 3 is a perspective schematic view of a configuration of multiple particle beam emitters in accordance with at least one embodiment;

FIG. 4 is planar schematic view of the configuration of multiple particle beam emitters of FIG. 3;

FIG. 5A is a schematic profile view of a cross section of a conducting plasma beam in a radial direction;

FIG. 5B is a schematic cross section view of a conducting plasma beam emitter;

FIG. 6 is a schematic view of a dimensionless Lorentz force distribution, due to a uniform distribution of plasma density in a common focal region;

FIG. 7 is a schematic view of a dimensionless Lorentz force distribution, due to an exponential distribution of plasma density in a common focal region;

FIG. 8 is a schematic view of a thermonuclear reaction system integrated with an existing nuclear reactor design;

FIG. 9 is a plot of simulation results showing density distribution in a radial direction for the common focal region of the symmetrical four beam configuration of FIG. 3;

FIG. 10 is a plot of simulation results showing pressure distribution in a radial direction and fusion power output for the common focal region of the symmetrical four beam configuration of FIG. 3;

FIG. 11 is a plot of simulation results showing temperature distribution in a radial direction for a natural lightening beam;

FIG. 12 is a profile of pulsed current used for neutron yield in accordance with at least one embodiment;

FIG. 13 is a data plot of neutron cross-sections for fission of uranium and thorium;

FIG. 14 is a schematic view of a fuel converter driven by a neutron source;

FIG. 15 is a schematic view of a fusion product collection system for a fuel converter driven by a neutron source;

FIG. 16 is a schematic view of an example nuclear fuel cycle;

FIG. 17 is a schematic view of a hybrid fusion/fission reactor based on a modified boiling water reactor;

FIG. 18 is a schematic view of a breeder reactor based on a modified pressurized water reactor;

FIG. 19 is a plot of simulation results showing mass concentration for the common focal region of the symmetrical four beam configuration of FIG. 3 and for the sun in its early age;

FIG. 20 is a plot of simulation results showing power density distribution in the radial direction for the sun in its early age;

FIG. 21 is a plot of simulation results showing pressure distribution in a radial direction and heat power distribution for a natural lightning beam; and

FIG. 22 is a plot of simulation results showing temperature in a radial direction and density for a natural lightning beam.

It will be understood that reference to the drawings is made for illustration purposes only, and is not intended to limit the scope of the embodiments described herein below in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

Various apparatuses, methods and compositions are described below to provide an example of an embodiment of each claimed invention. No embodiment described below limits any claimed invention and any claimed invention may cover apparatuses and methods that differ from those described below. The claimed inventions are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed invention. Any invention disclosed in an apparatus, method or composition described below that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The present application relates to a fusion neutron source based on the concept of high energy fuel carrying plasma beams passing through a common focal region. Various conditions including plasma velocity, temperature, and density are thought to be necessary to initiate fusion reactions, and plasma stability is thought to be a requirement to permit sufficient confinement time.

Satisfactory conditions of plasma velocity, temperature, and density necessary to initiate fusion have been achieved in various research facilities. However, attempts to achieve fusion with a net energy output have so far been unsuccessful. One reason is that the repulsive forces among the particles having the same charge near the central region may make sufficient density concentrations difficult to achieve. In general, the lack of success is because confinement time has not been sufficient due to plasma instabilities.

Here, we propose that plasma instabilities may be suppressed in the spherical focal region of a four plasma beam configuration symmetrical in space according to the minimization principle of potential energy. Confirmation tests are proposed using wires containing or encapsulating deuterium. If successful, the results may lead to a feasible approach to achieve commercial fusion power from water without the use of expensive and radioactive tritium as fuel. Alternatively or additionally, the results may lead to a feasible approach to achieve a compact neutron source from water without the use of expensive and radioactive tritium as fuel.

### Background

Stern Laboratories, of Hamilton, Ontario, Canada [“Stern”], is equipped with a 16 MW DC power supply with 13 individually controlled zones, which is one of the highest power and most versatile high current facilities in the world. Investigative tests were carried out at Stern where two plasma beams were successfully connected by an electric current. The connection centre of the plasma beams was observed to shift towards the positively charged electrode to an extent that the positive electrode was severely damaged by the hot plasma.

It is postulated here that this behaviour was caused by the movement of the electrons as a result of a physical attraction between the negatively charged electrons and the positively charged atomic nuclei in the plasma. The interaction between electrons and nuclei is consistent with a single plasma beam flowing in the same direction of these charged particles, in a way similar to the lightning strikes in nature, that may provide an alternative explanation on the source of neutrons detected during the Z-pinch tests (Zeta tests) performed at Harwell, UK in 1957 (Thonemann, P. C. et al., 1958).

It is proposed that the electrons in these tests gained kinetic energy exceeding the bounding energy of the nuclei and was sufficient to split the deuterons into protons and neutrons. The energy of the deuterons, in equilibrium with that of the electrons, was adequate for fusion. Such equilibrium was reached for the Zeta tests with a confinement time in the order of 1 ms. However, fusion did not occur as all the deuterons travelled in the same direction without sufficient relative velocity to overcome the energy barrier for deuterium-deuterium (D-D) fusion. USSR Z-pinch tests carried out in 1958 (Andrianov, A. M. et al., 1958) might have achieved some D-D fusion due to a target/beam mechanism, based on examination of the neutron energy spectra, although the amount of energy release was not adequate for the fusion reactions to be confirmed by measurements.

Early attempts to achieve controlled nuclear fusion were typically based on some variation of “pinch” machines where an axial electric current was applied inside a plasma in order to compress the plasma (see e.g. Thonemann, P. C. et al., 1958; Andrianov, A. M. et al., 1958; and McCracken, G. and Stott, P., 2005). In a straight cylindrical (linear) pinch, z is the axial coordinate and θ is the azimuthal coordinate; in a toroidal pinch, the current is toroidal and the field poloidal. Early Z-pinch tests were usually characterized by kink and sausage instabilities (McCracken, G. and Stott, P., 2005) which prevented the achievement of a sufficient confinement time to ignite and sustain fusion reactions. After decades of efforts to resolve the instability issues associated with the earlier Z-pinch machines, the mainstream efforts to achieve fusion shifted to tokamak machines where hotter plasma temperatures were measured together with an improvement of plasma confinement. Tokamak machines however, are challenged by the presence of an edge-localized mode [“ELM”], micro-level turbulence, tritium retention and material issues as well as structural complexity.

Meanwhile, Z-pinch tests initially switched to implosion of metal wires in an attempt to achieve fusion and have so far generated powerful x-ray emissions (Mosher, D. et al., 1973; Pereira, N. R. and Davis, J., 1988). By arranging the metal wires into an X-shape [or “X-pinch”] (Zakharov, S., M. et al., 1982; Shelkovenko, T., A. et al., 1999), using two wires passing through a single point, a record near-solid density and a temperature of 10 MK were observed at a micro pinch formed in the region of intersection (Sinars, D. B. et al., 2003). Alternatively, metal wire arrays were arranged in parallel (Burkhalter, P. et al., 1979; Apruzese. J. P. et al., 2001) and a record temperature of 2 GK was measured when tungsten wires were replaced by steel wires at Sandia Labs (Haines, M. D. et al., 2006). Using 192 laser beams focusing into a small deuterium-tritium (D-T) target through a cylindrical gold hohlraum (indirect drive), a plasma density of 600 g/cc was measured recently (Glenzer, S. H. et al., 2012).

While recent experiments (e.g. Sinars, D. B. et al., 2003; Haines, M. D. et al., 2006; Glenzer, S. H. et al., 2012) demonstrated that the extreme temperature and density conditions existing naturally in the centres of the stars, such as the Sun, have been achieved in laboratory conditions, the confinement times were too short to sustain fusion reactions due to limitations imposed by plasma instability.

An alternative approach to fusion power was proposed based on the concept of high energy fuel carrying particle beams passing through a common focal region, optionally assisted by laser beams (Zheng, X. J., 2011), and, as an enhancement, the intersection of at least two plasma beams pinched by electric currents (Zheng, X. J., 2012). As further improvement to the X-pinch concept, this innovative approach includes a multiple beam configuration, symmetrical in three dimensions with respect to each of the beams, which may improve plasma stability in the common focal region.

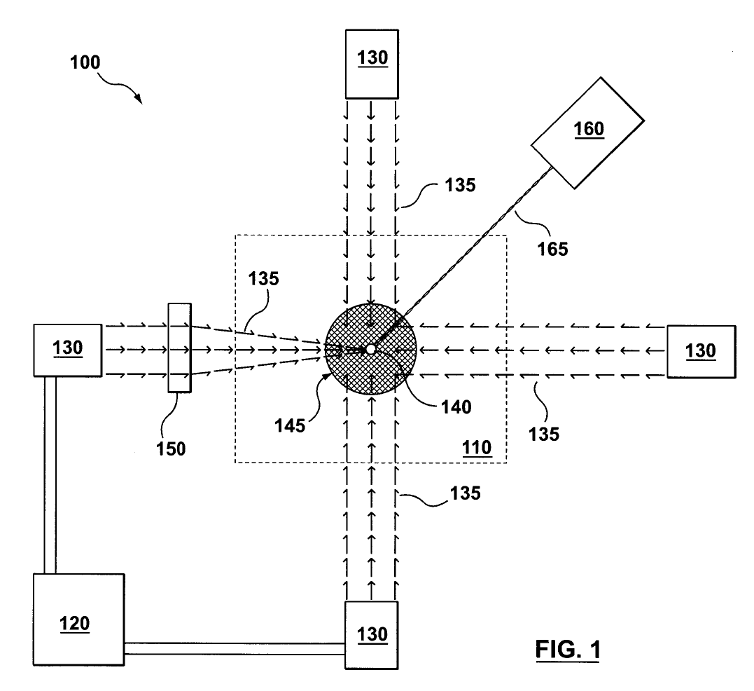

Referring initially to FIG. 1, there is illustrated a schematic view of a thermonuclear reaction system 100 in accordance with at least one embodiment described herein. Thermonuclear reaction system 100 includes a reaction chamber 110, a fuel injector 120, and a plurality of particle beam emitters 130 capable of generating a plurality of particle beams 135 composed of at least one type of thermonuclear fuel particle. The particle beam emitters 130 are supported spatially around and in fluid communication with reaction chamber 110, so that during operating of the thermonuclear reaction system 100, the particle beam emitters 130 emit the plurality of particle beams 135 into the reaction chamber 110. As discussed further below, the plurality of particle beams 135 are directed into the reaction chamber 110 wherein they interact in such a way that a thermonuclear reaction may be instigated within the reaction chamber 110, which in at least some cases may be continuous (or pseudo-continuous) and self-sustaining.

The particle beams 135 may be composed wholly or in some cases only partially of high energy particles existing in a plasma state. Where the particle beams 135 are not composed wholly of plasma particles, the non-plasma particles within the particle beams 135 may retain a net charge, for example, a positive charge due to electron loss during ionization. In some embodiments, the non-plasma particles within the particle beams 135 may be neutralized within the reaction chamber 110 subsequently to being emitted from the particle beam emitters 130. Alternatively, in some embodiments, the non-plasma particles within the particle beams 135 may retain their net charge within the reaction chamber 110. Either may be used for the design of thermonuclear reaction system 100. However, one disadvantage of utilizing particle beams 135 at least partially containing charged, non-plasma fuel particles may be the repulsive electrostatic forces that exist generally between any two charged particles. On account of the repulsive electrostatic force, it may be more difficult to realize a sufficiently high density of fuel particles within the reaction chamber 110 so as to initiate and sustain a thermonuclear reaction. By neutralizing any charged, non-plasma fuel particles within the reaction chamber 110 and thereby eliminating repulsive electrostatic forces between fuel particles in the particle beams 135, particle densities required for thermonuclear fusion may generally be easier to attain within the reaction chamber 110.

In some embodiments, the particle beams 135 may be generated by ionizing a supply of the at least one type of thermonuclear fuel particle provided by the fuel injector 120. After ionization, the charged particles within the particle beam emitters 130 may then be accelerated toward the reaction chamber 110. To neutralize any charged, non-plasma particles in the particle beams 135, for example, a supply of a low-pressure reactive gas may be pumped or otherwise provided into the reaction chamber 110 through a suitable gas inlet, so that individual charged particles in the particle beams 135 react with the neutralizing gas within the reaction chamber 110 and lose any retained charge.

As shown in FIG. 1, each of the particle beams 135 is directed toward a common focal region 140 of reaction chamber 110. The particle beams 135 may be directed toward the common focal region 140 by arranging the particle beam emitters 130 around the reaction chamber 110 in any suitable three-dimensional spatial orientation. For example, the particle beam emitters 130 may be arranged in a substantially spherical arrangement around the reaction chamber 110 or otherwise so that the particle beam emitters 130 are essentially equidistant from the common focal region 140. Alternatively, the particle beam emitters 130 may be arranged to be substantially symmetric in at least three different planes (e.g., as defined in a Cartesian coordinate system), which may in some cases be mutually orthogonal. However, other three-dimensional spatial orientations for the particle beam emitters 130 are possible as well.

In some embodiments, converging elements 150 may be provided in the path of the particle beams 135 to assist in directing the particle beams 135 towards the common focal region 140. While only one example of the converging elements 150 is explicitly illustrated in FIG. 1, in some embodiments, additional converging elements may be included in thermonuclear reaction system 100. Each of the converging elements 150 included may be associated with a single one of the particle beams 135 or, alternatively, two or more of the particle beams 135.

In some embodiments, where the particle beams 135 contain at least some charged, non-plasma fuel particles, some of the convergent elements 150 may be implemented using a magnetic lens. For example, the magnetic lens may consist of several electromagnetic coils arranged into a quadrupole, a sextupole, or some other suitable arrangement. When the electromagnetic coils are energized, the resulting quadrupolar or sextupolar magnetic field has a generally convex shape that deflects charged particles travelling through the magnetic field. The amount of deflection may be controllable based upon the strength of the magnetic field, which in turn may be controlled by varying the energizing current supplied to the electromagnetic coils. In this way, the magnetic lens may be effectively utilized to focus or otherwise converge the particle beams 135 at the common focal region 140.

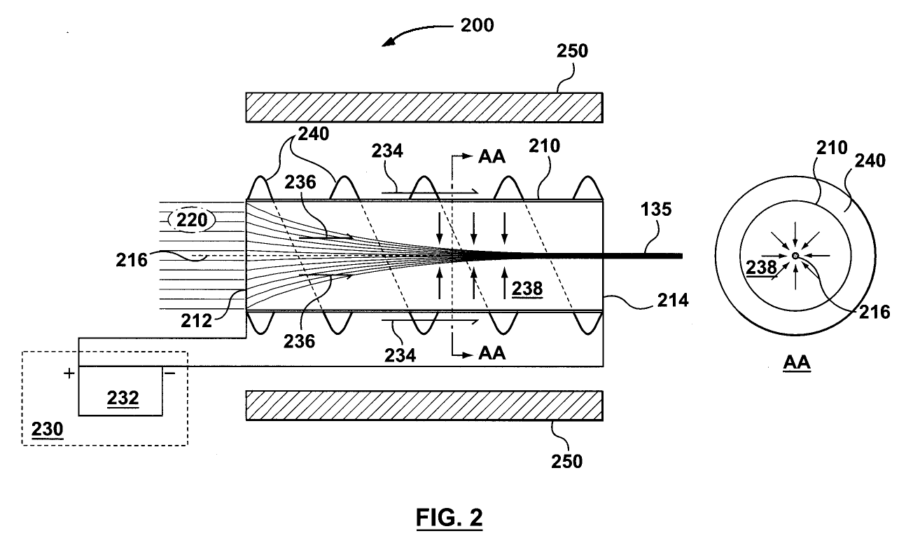

Alternatively, some of the converging elements 150 may be implemented using an electrostatic lens configured as a focusing element of charged particle beams. For example, in some embodiments, the electrostatic lens may be an Einzel lens, a cylinder lens, an aperture lens or a quadrupole lens. In some embodiments, the converging elements 150 may be a mixture of magnetic and electrostatic lenses.

Where the particle beams 135 are composed completely or nearly completely of plasma fuel particles, electrostatic or magnetic lenses will not generally be suitable for implementing the converging elements 150 because the plasma particles are electrically neutral overall and therefore not generally responsive to electromagnetic fields. However, it may still be possible to alter the path of a neutral particle beam existing in complete or near complete plasma state and thereby focus the particle beams 135 at the common focal region 140. One example configuration to achieving this result is described below in more detail with reference to FIG. 2.

The inside surface of the reaction chamber 110 may be coated with a suitable insulating material to absorb any high energy gamma-rays produced during the thermonuclear reactions taking place within the reaction chamber 110. Different materials having generally different thermal and electrical properties may be used to coat the inside surface of the reaction chamber 110. For example, melting point and heat absorption capability may be two of the relevant considerations for choosing an appropriate coating material. As a coolant liquid (not shown) may be applied also to the inside surface of the reaction chamber 110 in some embodiments, another relevant consideration for the coating material may be its chemical reactivity with the particular coolant fluid used. A coating material that is generally non-reactive with the coolant liquid may be preferable. In some embodiments, nuclear graphite or graphene, tungsten or other materials having melting points equal to or greater than those of graphite and tungsten may be used for the material used to coat the inside surface of the reaction chamber 110.

Converging the particle beams 135 at the common focal region 140 causes the particle density existing at the common focal region 140 to increase. If the particle density rises to sufficiently high levels, a plasma sphere 145 having a sufficiently high temperature so as to instigate a thermonuclear fusion reaction within the reaction chamber 110 may be created in the vicinity of the common focal region 140. For example, the density of the plasma sphere 145 may be comparable to the densities found in the center of the Sun (i.e., up to 160,000 kg/m³). By converging a sufficiently large number of the particle beams 135, each of which is composed of thermonuclear fuel particles accelerated with sufficient kinetic energy, the required particle densities for sustained thermonuclear reactions may be achieved in the reaction chamber 110. This result is also achieved without the contribution of gravity effects present in stars that assist in sustaining the thermonuclear reactions that naturally occur in those and similar environments. Rather, particle and energy concentration may be realized in the reaction chamber 110 through the acceleration and convergence of particle beams 135 at common focal region 140.

Optionally, an additional supply of input energy into the reaction chamber 110 may be directed toward to the common focal region 140 in order to assist in igniting the plasma sphere 145 and thereby instigate the thermonuclear reaction. Accordingly, in some embodiments, a plurality of lasers 160 may be arranged spatially around reaction chamber 110 and, like the particle beam emitters 130, oriented toward common focal region 140 near the center of the reaction chamber 110. The 160 may generate and emit a plurality of laser beams 165 that also are convergent at common focal region 140. In some embodiments, laser guide tubes made of, for example, glass fibers (not shown) may extend some depth into reaction chamber 110 in order to guide the laser beams toward the common focal region 140.

In alternative embodiments, supplemental energy input devices (not shown) other than, or in addition to, the lasers 160 may also be used for igniting the plasma sphere 145 to assist instigation of thermonuclear reactions. For convenience only, and without limitation, only a single one of the lasers 160 is shown explicitly in FIG. 1, although more than one laser or other supplemental energy input device may be used. Moreover, any number of lasers 160 may be included and may be arranged spatially around the reaction chamber 110 in any suitable arrangement in order to accommodate the desired number of lasers 160.

In some embodiments, the energy generated by the thermonuclear fusion reactions occurring at or near common focal region 140 may be sufficient to maintain the plasma sphere 145 at a sufficiently high temperature that continuous and sustained thermonuclear reactions may be instigated without the use of supplemental energy input devices (e.g., lasers 160). Accordingly, in some embodiments, the lasers 160 or other supplemental energy input devices may be omitted from the thermonuclear reaction system 100 and convergence of a sufficient number of the particle beams 135 accelerated to sufficient kinetic energies may suffice by themselves to both ignite and sustain thermonuclear fusion reactions.

However, convergence of the particle beams 135 by itself may not be sufficient to ignite the plasma sphere 145 and instigate a thermonuclear fusion reaction. Accordingly, in some embodiments, the lasers 160 or other supplemental energy input devices may be operated initially until a thermonuclear fusion reaction has been instigated within the reaction chamber 110, but thereafter then disabled. In that case, the heat generated from particle collisions due to convergence of the particle beams 135 may be sufficient to sustain continuous thermonuclear reactions within the reaction chamber 110 without benefiting from additional input energy supplied by the lasers 160 or other supplemental energy input devices.

In some embodiments, starter inductors (not shown) are used to initiate the fusion reaction. The starter inductors connect the particle beam emitters 130 through the common focal region 140. These inductors may simply be hollow metal (e.g., copper) or non-metal (e.g., graphite) pipes. Some of the inductors may contain particle beams 135 directed towards the common focal region 140, while the others may contain outgoing particle beams along with fusion products. These starter inductors are used to establish initial boundary conditions for the colliding/penetrating fuel particle beams to converge into their final pinched configurations. Voltages and electric currents are then applied to these starter inductors and, when the starter inductors melt and/or vaporize due to Joule heating, starting from the common focal region 140, the particle beams 135 rapidly become electrically conducting lightning bolts that collide and penetrate each other at the common focal region 140.

It will be appreciated that different combinations and configurations of the elements described herein may be possible in different embodiments of the thermonuclear reaction system 100.

Reference is now made to FIG. 2, which illustrates a schematic view of an exemplary particle beam emitter 200, which may be used to implement any or all of the particle beam emitters 130 shown in FIG. 1 in accordance with at least one embodiment. Particle beam emitter 200 includes a hollow cylindrical particle beam tube 210 having a first end portion 212, a second end portion 214 and an inner surface (not shown). Particle beam tube 210 may be composed of an electrically conductive material having a melting temperature substantially above an equilibrium temperature for the formation of the high energy plasma or ionized particles housed within the particle beam emitter 200. In certain embodiments, particle beam tube 210 may be formed of a material or composition having a melting temperature exceeding 1,800° C. Alternatively, the inner surface of the particle beam tube 210 may be coated with a material or composition having a melting temperature of 1,800° C. or higher. Examples of suitable materials for forming or coating the inner surface of the particle beam tube 210 include, but are not limited, to tungsten and graphite. In some embodiments, particle beam tube 210 may be composed of a hollow graphene cylinder coated on the inner surface with a layer of tantalum hafnium carbide (Ta₄HfC₅), which has a melting point of about 4200° C., or some other chemical compound having a generally higher melting point than carbon based materials such as graphene.

In the example arrangement illustrated in FIG. 2, first end portion 212 of particle beam tube 210 is in fluid communication with a fuel injector (such as fuel injector 120 shown in FIG. 1) to receive a plasma 220 containing at least one type of thermonuclear fuel particle. For example, the plasma 220 may contain particles of ₁¹H or ₁²D or some other type of thermonuclear fuel particle. Plasma 220 may typically be provided by the fuel injector to the particle beam tube 210 at a relatively high pressure and temperature. In order to provide the supply of the plasma 220 to the particle beam emitter 200, the fuel injector may convert an internal or separate external supply of thermonuclear fuel particles into their plasma state by heating and/or ionizing processes prior to the plasma 220 being received into the first end portion 212 of the particle beam tube 210. In some embodiments, the ionizing processes can generate non-thermal plasma, wherein the electrons and ions are not in thermal equilibrium, and wherein the ions can stay at a relatively low temperature. In other embodiments, the plasma temperature is relatively low as only a small fraction, e.g., 1%, of the fluid molecules are ionized. Utilization of non-thermal plasma can reduce the local thermal load experienced by the particle beam tube 210 at its first end portion 212 in these embodiments. As an example in nature, non-thermal plasma is theorized to exist in the initial formation stage of a lightning beam, wherein fast electrons ionize the water vapor and/or air molecules by a process commonly known as Joule heating before an equilibrium state is reached between electrons and ions.

Second end portion 214 of particle beam tube 210 is located opposite to the first end portion 212 and may be in fluid communication with the reaction chamber 110 (FIG. 1). This allows particle beam emitter 200 to emit a corresponding one of the particle beams 135 (FIG. 1) into reaction chamber 110. In some embodiments, at least a portion of second end portion 214 partially extends into reaction chamber 110 to a desired depth. The extension depth of the second end portion 214 may be varied depending on the application and to meet design and/or performance criteria for the thermonuclear reaction system 100 (FIG. 1). However, a minimum distance between second end portion 214 of each particle beam tube 210 and common focal region 140 (FIG. 1) should be maintained to ensure safe operation of the particle beam emitter 200 under the extreme operating conditions prevailing within reaction chamber 110.

Particle beam emitter 200 may also include an electromagnetic system 230 for generating an electromagnetic field (not shown) to provide radial confinement and linear acceleration of plasma 220 within particle beam tube 210 using a variation of the “pinch” concept (sometimes also referred to as the “Z-pinch” concept). According to the pinch concept, the interaction between an electrical current flowing through plasma and an induced (and/or externally applied) magnetic field causes inward compression of the plasma in a direction orthogonal to the direction of the current flow through the plasma. In effect, by inducing an axial current flowing in a direction parallel to a central axis 216 of particle beam tube 210, plasma 220 behaves somewhat like a plurality of current-carrying wires where each wire is carrying current in the same axial direction. Consequently, the plasma “wires” are each pulled toward each other by the mutually acting Lorentz forces, the overall result of which being that plasma 220 contracts itself inwardly toward the central axis 216 of particle beam tube 210 wherein the plasma 220 is concentrated. As plasma 220 contracts inwardly and concentrates, the density of plasma 220 increases; denser plasmas may generate denser magnetic fields, increasing the inward force acting on plasma 220, and further compressing and concentrating the plasma 220 in the vicinity of the central axis 216.

In order to achieve pinching of the plasma 220, the electromagnetic system 230 may include a voltage supply 232 electrically coupled to particle beam tube 210 and configured to generate a primary electrical current 234 flowing in the hollow cylindrical section of particle beam tube 210. For example, the voltage supply 232 may create a potential difference between first end portion 212 and second end portion 214 so that the primary electrical current 234 flows therebetween around the entire or substantially the entire periphery of the hollow cylindrical section. The magnetic field associated with the primary electrical current 234 induces a secondary electrical current 236 flowing generally axially within plasma 220 that creates the z-pinch effect detailed above.

When the parameters of primary electrical current 234 are suitably controlled (e.g., frequency and amplitude), secondary electrical current 236 will interact with the magnetic field associated with the primary electrical current 234 to generate a radial force field 238 within particle beam tube 210. Radial force field 238 is directed generally inwardly towards central axis 216. Radial force field 238 will urge any plasma 220 present in particle beam tube 210 toward central axis 216. As the density of plasma 220 increases, the resulting pressure gradient accelerates plasma linearly along central axis 216. A pressure valve or the like (not shown) at first end portion 212 prevents the plasma 220 from flowing back towards the fuel injector, and forces plasma 220 toward second end portion 214 at a relatively high velocity, where it is ejected from particle beam emitter 200 into the reaction chamber 110 as one of the particle beams 135. The exit velocity of the particle beams 135 may be controlled according to the pressure gradient experienced by plasma 220 during the electromagnetic pinch: the higher the pressure gradient experienced by the plasma 220, the higher the exit velocity of the particle beams 135.

In some embodiments, the voltage supply 232 may be coupled to the particle beam tube 210 included in each of an opposing pair of the particle beam emitters 130. As used herein, two of the particle beam emitters 130 may be understood to oppose one another when oriented approximately 180-degrees apart in a common plane so that the pair of particle beam emitters 130 are substantially in opposition to one another along a linear trajectory. Accordingly, when the particle beams 135 are emitted from the particle beam emitters 130 and the plasma sphere 145 is ignited, a closed electrical loop may be formed between each opposing pair of the particle beam emitters 130 and the voltage supply 232 via the particle beams 135 and the plasma sphere 145. The voltage supply 232 (or alternatively another suitable voltage supply) may also be coupled to multiple opposing pairs of the particle beam emitters to form multiple corresponding closed electrical loops.

A high voltage initially supplied by the voltage supply 232 may be used to electrify individual fuel particles contained in the opposing pair of the particle beam emitters 130 forming part of the closed electrical loop. In some embodiments, the fuel particles are initially at a relatively low temperature (e.g. ˜300°K) as they enter first end portions 212 of an opposing pair of the particle beam emitters 130. In response to application of the high voltage, the fuel particles may be turned into plasma 220 and thereafter develop the electrical current 236 that causes pinching of the plasma 220 toward the central axis 216. Due to the closed electrical looping, the pinching may occur both within the particle beam tube 210, but may also continue as the particle beams 135 travel toward and converge at the common focal region 140, thereby further raising the particle density realized within the plasma sphere 145. The initially applied high voltage may be maintained or thereafter reduced to a minimum maintenance voltage in order to supply a desired level of constant electrical current in order to achieve desired level of energy concentration around the central axis 216 in the opposing pair of the particle beams 135. However, a sufficient electric current needs to be maintained in order to pinch the particle beams in the form of lightning bolts into a desired size. The particle beams become plasma and lightning bolts due to Joule heating by the electric current soon after leaving their emitters. The number of pairs of the particle beams 135 included in closed electrical loops may also vary in order to create a desired level of energy concentration at common focal region 140 due to focusing of the particle beams 135.

In some embodiments, sufficiently large DC currents are used to pinch the particle beams 135 into continuous lightning bolts. In other embodiments, sufficiently large AC currents are used instead to form lightning bolts at reduced input power costs. The AC parameters such as intensity, frequency, and phase angle may be optimized to maximize the fusion reaction rate based on computer simulation and test results. For example, the phase angles of the AC currents in multiple lightning bolts may be arranged to generate shock waves in the particle beams 135 directed towards the common focal region 140 to maximize the energy concentration at the plasma sphere 145.

In some embodiments, sufficiently DC, AC, or pulse currents may be used to form plasma beams (which may be characterized as lightning bolts) having levels of electric current, beam diameter, beam velocity, and temperature similar to typically occurring lightning beams that may be observed in nature.

In some embodiments, electromagnetic system 230 also includes a plurality of electromagnetic coils 240 aligned axially about central axis 216 along at least a portion of particle beam tube 210. Electromagnetic coils 240 are used to generate an axial magnetic field (not shown) within particle beam tube 210 that provides supplemental axial confinement of plasma 220 within particle beam tube 210. Consequently, the stability of the plasma 220 is increased as the plasma 220 is compressed along central axis 216 (as will be discussed further below). Electromagnetic coils 240 may typically surround particle beam tube 210 and may generally be located in close proximity to particle beam tube 210. In certain embodiments, the exterior of particle beam tube 210 supports the electromagnetic coils 240, although electromagnetic coils 240 may be separated from particle beam tube 210 by suitable thermal and/or electrical insulation members (not shown). Inclusion of electromagnetic coils 240 within the particle beam emitter 200 is optional and, in some cases, may depend on the required velocity of particle beams 135 for a particular fusion reactor design.

Alternatively, or additionally, particle beam emitter 200 may include external magnets 250 to provide supplemental radial confinement of plasma 220 within particle beam tube 210. External magnets 250 may include permanent magnets or electromagnets, and may be arranged in any suitable configuration that provides the desired magnetic field and desired supplemental confinement.

For example, the position of the external magnets 250 relative to the particle beam tube 210 may be fixed or the external magnets 250 may be movably secured in relation to the particle beam tube 210 so as to be movable about the particle beam tube 210. The magnetic field generated by the external magnets 250 may therefore be static or time-varying as the case may be.

In some embodiments, the particle beam emitter 200 may include one pair of permanent magnets or electromagnets that are rotatable about the central axis 216. The time-varying magnetic field resulting from rotation of the external magnets 250 about the central axis 216 is also used to induce the secondary electrical current 236 within plasma 220 flowing in a generally axial direction (i.e., parallel to the central axis 216). To be rotatable about the central axis 216, the external magnets 250 may be attached to or otherwise supported by the particle beam tube 210. Alternatively, the external magnets 250 may be supported by an external support system (not shown) proximate to the particle beam tube 210.

In some embodiments, the external magnets 250 may include more than one pair of permanent magnets or electromagnets. Each pair of permanent magnets or electromagnets may be supported within the particle beam emitter 200 using a similar arrangement to what is described above. The configurations of each pair of permanent magnets or electromagnets may be identical or may vary with respect to one another. For example, the radial distance to the central axis 216 may be the same or different from pair to pair. Accordingly, at least one pair of permanent magnets or electromagnets may be spaced apart from the central axis 216 by a different radial distance from at least one other pair. Alternatively, each pair of permanent magnets or electromagnets may have the same radial spacing relative to the central axis 216.

The axial length and positioning of the external magnets 250 may also be varied in different embodiments. For example, in some embodiments, the external magnets 250 may span the entire axial length or nearly the entire axial length of the particle beam tube 210 (this arrangement is shown in FIG. 2 for illustrative purposes only). Alternatively, in some embodiments, two or more of the external magnets 250 separated by air gaps may be arranged in axial alignment along the length of the particle beam tube 210. In this case, the width of the air gaps between the external magnets 250 in axial alignment may be approximately equal. For example, two or three or any other suitable number of the external magnets 250 may span the axial length of the particle beam tube 210.

In some embodiments, particle beam emitter 200 is operated with a thermonuclear fuel mixture comprised of hydrogen and deuterium gases. The hydrogen and deuterium gases are heated in a fuel injector (such as fuel injector 20) in order to dissociate electrons from the hydrogen and deuterium nuclei until the hydrogen and deuterium gases exist in their plasma states, thereby forming the plasma 220. Typically, this will involve heating the thermonuclear fuel mixture within the fuel injector to a temperature of at 1,800° C. or higher. Once heated, the mixture of hydrogen and deuterium plasma is supplied to first end portion 212 of particle beam tube 210 from the fuel injector. Inside the particle beam tube 210, the primary electrical current 234 generated by electromagnetic system 230 induces the secondary electrical current 236 within the plasma 220. As discussed above, the resulting electromagnetic field provides radial confinement and axial acceleration of the plasma 220 toward the second end portion 214.

In order to heat up the hydrogen and deuterium gases, the fuel injector in some embodiments may include a plurality of fuel channels fed through at least one high temperature furnace. The hydrogen and deuterium gases are pumped through the fuel channels (each fuel channel may house only one of the two gases) wherein heat radiated from the high temperature furnace brings the hydrogen and deuterium gases to the desired temperatures. To withstand the heat generated by the high temperature furnace, each of the fuel channels may be composed of a material or material composition having a very high melting point, for example, well above 1,800° C. For example, as noted above, graphite and tungsten are some non-limiting examples of suitable materials for the fuel channels.

Alternatively, in some embodiments, the hydrogen and deuterium gases may be mixed together within the fuel injector and converted into their plasma states through heating by other mechanisms or processes. For example, the mixture of hydrogen and deuterium gases may be subject to high-frequency electromagnetic waves during transport through the fuel injector to the particle beam emitter 200. The energy imparted by the high-frequency electromagnetic waves may be used to increase the kinetic energy of the pumped hydrogen and deuterium to high enough levels. Heating by high-frequency electromagnetic waves is similar to what takes place in some current tokamak machines, such as ITER. The fuel injector again may be formed or coated from a material or material composition having a very high melting point, for example, well above 1,800° C. Graphite, tungsten and tantalum hafnium carbide (Ta4HfC5) provide some non-limiting examples of suitable materials for the fuel injector.

The schematic arrangement shown in FIG. 2 is merely illustrative, and other arrangements could be used to effect particle beam emission. For example, each particle beam emitter 200 may comprise a plurality of particle beam tubes (similar to the particle beam tube 210), and each of the particle beam tubes may be capable of emitting one of the particle beams 135 into reaction chamber 110. That is, in some embodiments, the particle beam emitter 200 may be capable of emitting a plurality of particle beams 135 into reaction chamber 110.

Referring now to FIGS. 1 and 2, in some embodiments, one or more particle beam tubes (such as the particle beam tube 210) may extend into reaction chamber 110 by a certain distance to provide (additional) directional guidance to particle beams 135 in order to increase the convergence at common focal region 140 with other individual particles beams in the particle beams 135. However, a minimum distance between the second end portion 214 of each particle beam tube 210 and common focal region 140 should be maintained to ensure safe operation of particle beam emitters 130 under the extreme operating conditions in reaction chamber 110.

The second end portion 214 of the particle beam tube 210 may also be modified to have a gentle and smooth bend into a desired direction. The curvature of the second end portion 214 may be controlled to slightly alter or deviate the direction of the primary electrical current 234 near the second end portion 214. Consequently, the secondary electrical current 236 induced by the magnetic field associated with the primary electrical current 234 would also bend or deviate into the same desired direction due to the coupling between the primary electrical current 234 and the secondary electrical current 236. The deviation of the secondary electrical current 236 then alters the electromagnetic field within the particle beam tube 210 in a way that the high-energy particles emitted from the particle beam tube 210 are focused at and converge upon the common focal region 140. As noted above, this alternative confirmation of the particle beam emitter 200 may be used as an alternative or in addition to the converging elements 150.

### Four Beam Configuration

A configuration with multiple sets of orthogonal pairs of particle beam emitters 130 may be used in a spherical fusion chamber, in order to increase energy concentration by focusing, and also improve the stability of the plasma sphere 145.

The two beam connection tests at Stern were initially prepared to achieve collision of the two plasma beams at the geometric centre of the connection, assuming that the movement of the electrons driven by the applied voltage would not affect the flows of the two plasma beams. Contrary to expectations, the test results indicated a clear shift in connection centre towards the positively charged electrode. This indicates that a spatial symmetry may not be sustainable without counter balancing electro-magnetic fields. While it will be appreciated that symmetry in three-dimensional (3D) space cannot be achieved by two opposing plasma beams in one line (one-dimensional), nor may symmetry in three-dimensional (3D) space be achieved with two intersecting beams which are planar (two-dimensional). Furthermore, such symmetry cannot be arranged with three beams in 3D space, due to the existence of a nonzero vector sum of electric currents at the connection centre. Such a nonzero vector sum prevents the formation of counter balancing electro-magnetic fields in the plasma region at the connection centre.

At least four plasma beams are thought to be required to achieve and sustain spatial symmetry of a plasma sphere in three dimensions, as explained below. The spatial symmetry in the 3D space is defined here as having all beams identical to one another except for their orientations, with the relative angles between the beams evenly distributed in space. At the focal point of intersection, the vector sum of the counter-balancing electro-magnetic fields is preferably zero.

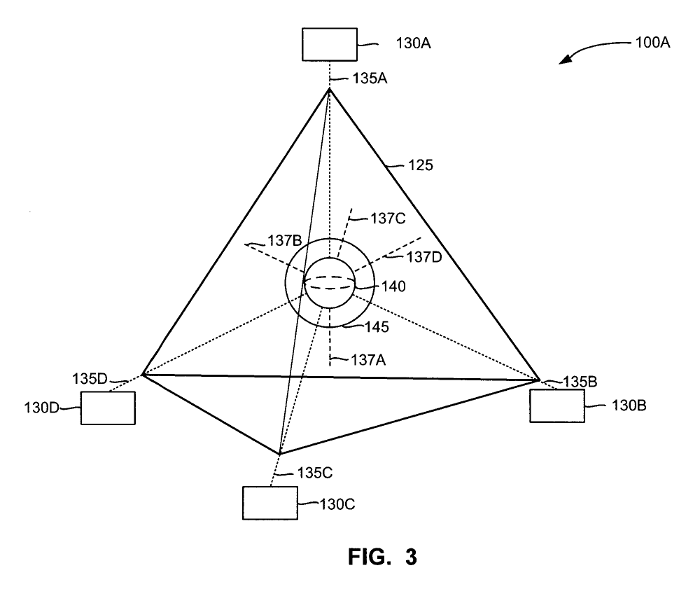

FIG. 3 illustrates a system 10 A comprising a four beam configuration that has spatial symmetry in 3-D space. Spatial symmetry in the 3-D space may be characterized as having all beams identical to one another except for their orientations, with the relative angles between the beams evenly distributed in space. The pyramid shape 125 is shown to assist visualization of the plasma beam orientations.

System 100A comprises four particle beam emitters 130A, 130B, 130C, and 130D that each emit a plasma beam 135A, 135B, 135C, and 135D, respectively, towards a common focal region 140, which is at the geometric center of system 100A. The plasma region 145 at the focal region 140 is expected to be spheroidal, with identical (or substantially identical) plasma dimensions in the axial directions of the four beams, and is approximated as a sphere in FIG. 3. The plasma region 145 may be subjected to converging magnetic forces, as well as dynamic pressure due to converging plasma flows, as a consequence of applied electric currents. The plasma region may collapse radially into the geometric center under the applied currents.

Opposite each particle beam emitter 130A-D, on the other side of focal region 140, is an associated particle beam receiver (not shown in FIG. 3 for clarity). A particle beam receiver acts as an electrode for a plasma beam travelling from a particle beam emitter—the particle beam emitter also functioning as an electrode—so that an electrical current may be applied to the plasma beam. That is, a particle beam emitter and its associated particle beam receiver act as a pair of oppositely charged electrodes in order to connect a single plasma beam travelling between them. Preferably, the particle beam emitter acts as a negative electrode and the particle beam receiver acts as a positive electrode. The plasma beam flows from the negative to positive electrode in the same direction as the electrons.

In some embodiments, a particle beam receiver may comprise a piece of metal (and/or another electrically conductive material) that is positioned to be in contact with a plasma beam 135 being emitted by a particle beam emitter 130. Preferably, such a particle beam receiver has a similar structure to the particle beam emitter 200 shown in FIG. 2, except that the flow directions of electric current and plasma fluid are reversed, and the cylindrical wall of the emitter is connected to (and/or may function as) the positive electrode.

Also, where a particle beam receiver has a hollow structure (e.g. where a particle beam receiver has a similar structure to particle beam emitter 200), the particle beam emitter may allow passage and/or collection of the plasma fluid in a plasma beam as part of a closed loop fluid circulation system.

Preferably, the particle beam receivers are designed to minimize electric current density at local regions and avoid possible melting of the component under high temperature.

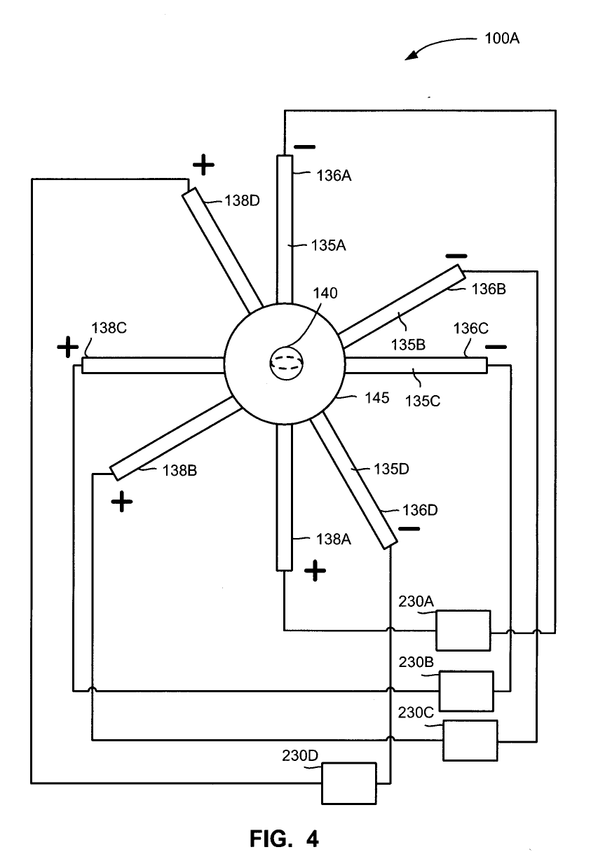

As shown in FIG. 4, each plasma beam 135A-D has a negative end 136A-D and a positive end 138A-D, respectively, with a particle beam emitter 130 located at the negative end, and a particle beam receiver located at the positive end. Power sources 230A-D are operatively coupled to the positive and negative end of each plasma beam in order to generate an electric current within each plasma beam. In this way, power sources 230A-D may generate a closed electrical loop that runs through a plasma beam 135 between its emitter 130 and corresponding receiver, and through the plasma region 145 in the common focal region 140.

In some embodiments, power sources 230A-D may be able to supply a sufficiently high voltage to electrify individual fuel particles contained in the opposing pair of particle beam emitter and receiver. Such a voltage may be maintained or thereafter reduced to a minimum maintenance voltage in order to supply a desired level of electrical current running through the entire plasma beam.

It will be appreciated that power sources 230A-230D may be, for example, voltage or current sources, AC or DC sources, pulse width modulation sources, or any suitable combination thereof. It will also be appreciated that the positive and negative ends of each plasma beam may be switchable, although one would have to switch all of the positive and negative ends to maintain the symmetry for achieving stability at the plasma region 145. For example, in the case of an AC power source with a frequency of 60 Hz, the emitter and receiver switch their roles 60 times in a second, but in the case of a DC source, their roles would not change over time.

As shown, each plasma beam flows through common focal region 140 and plasma sphere 145 and exits from the other side. Any two beams moving into or out of common focal region 140 form an identical angle of 109.5°. For example, the negative ends 136A and 136B of plasma beams 135A and 135B, respectively, have an angle of 109.5° between them, and the corresponding positive ends 138A and 138B of 135A and 135B, respectively, on the other side of common focal region 140 also have an angle of 109.5° between them.

In some embodiments, a plasma core temperature sufficient for nuclear fusion may be achieved due to a relatively high current running through each plasma beam that accelerates electrons into large velocities in the applied electric field. These fast moving electrons in turn attract the oppositely charged nuclei to achieve large velocities that become temperature due to particle collision and penetration at the dense core.

The configuration illustrated in FIG. 3 and FIG. 4 is preferred for its simplicity associated with a minimum electro-magnetic interference among the intersecting beams, and may alternatively be referred to as a four beam “star-pinch” due to its symmetry in space. The characteristics of such a star-pinch include:
Each plasma beam has materially similar, and preferably identical, dimensions, and each beam is subject to a similar, and preferably identical, applied current;
Any two beams moving into or out of the connection centre form an angle of 109.5°;
Each plasma beam preferably flows through the common focal region and exits the common focal region on the opposite side;
The common focal region is preferably a region of collision and penetration among electrons and ions;
Collisions are expected as a result of plasma flow in each beam being resisted by the three other opposing beams;
The vector sum of the electric currents at the common focal region is preferably as small as practicable, and more preferably zero;
A hot and dense core may form within the plasma region, surrounded by a cooler shell of plasma; and
Such a hot and dense core may facilitate fusion reactions under the condition of plasma region stability.

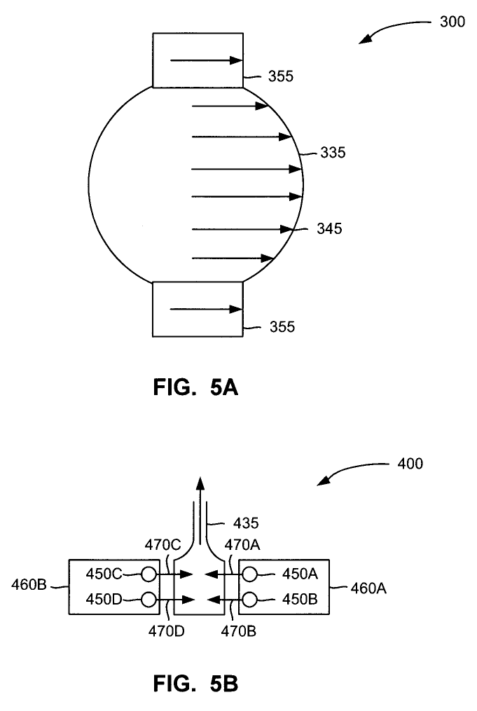

Reference is next made to FIG. 5A, which illustrates a schematic profile 300 of a cross section of a conducting plasma beam (formed out of water in this embodiment) in a radial direction. Plasma beam profile 300 comprises a plasma beam 335, plasma fluid 345 (e.g. deuterium), and a cylindrical oxygen shell 355 that encircles plasma beam 335. The arrows show the flow direction of the plasma fluid that is the same as the flow direction of the electrons (opposite to the current direction). The cylindrical oxygen shell can act as a resistive wall to confine and stabilize the hydrogen isotopes (e.g., deuterium) for fusion reactions at the common focal region.

Reference is next made to FIG. 5B, which illustrates a schematic cross-section of a conducting plasma beam emitter 400. Plasma beam emitter 400 comprises an electrode 460A and 460B, and the Figure illustrates a plurality of electrons 450A-D travelling in the direction of the corresponding electron flow 470A-D to form a plasma beam 435 travelling in the direction indicated, and also illustrates the reduction of beam diameter as the beam is ‘pinched’. It will be appreciated that the view shown in FIG. 5B may be characterized as a high-level schematic view of an emitter 200 (e.g. as shown in FIG. 2).

### Lorentz Force Distribution in Radial Direction

Consider a point along the axis for an arbitrary first one of the four plasma beams, at a distance of r away from the geometric centre of the common focal region. The magnetic field within this first beam along its central axis (due to the applied electric current) is expected to be zero. Assuming uniform distributions of density and electric charges in the four plasma beams, and neglecting the term due to the electric field, the magnetic field B generated by an electric current I_{c} for each of the remaining three plasma beams may be calculated by:

$$B = \frac{{μ}_{0} {I}_{c}}{2 π {R}_{focal}^{2}} ( r cos β ) \qquad ( 15 )$$

where R₀ (>r) is the cross-sectional radius of each plasma beam, also considered here to be the radius of the common focal region (R_{focal}), r cos β is the distance from the central axis of the first beam to the central axes of the remaining three beams (β is defined here as 109.5°-90°, i.e., β=19.5°, to avoid a negative sign in Equation (15)) and μ₀ is a magnetic constant also called vacuum permeability. Superposition of the Lorentz forces in the radial direction of the four beams at the common focal region allows the sum per unit volume, fₘ, to be calculated as:

$${f}_{m} = 3 B \frac{ {I}_{c}}{π {R}_{focal}^{2}} cos β = \frac{3 {μ}_{0} {I}_{c}^{2} {r ( cos β )}^{2}}{2 {π}^{2} {R}_{focal}^{4}} \qquad ( 16 )$$

Alternatively, the total Lorentz force per unit mass, in units of acceleration, may be calculated as

$${g}_{L} ( r ) = \frac{{f}_{m}}{{ρ}_{focal}} = 3 B \frac{{I}_{c}}{{πρ}_{focal} {R}_{focal}^{2}} cos β = \frac{3 {μ}_{0} {I}_{c}^{2} {r ( cos β )}^{2}}{2 {π}^{2} {ρ}_{focal} {R}_{focal}^{4}} \qquad ( 17 )$$

Equation (17) reflects a self-focusing effect of the four beams passing through the common region of intersection. The relationship between the above dimensionless Lorentz force and r is linear. A similar linear relationship is observed on gravity for a massive sphere with a uniform density of ρₛ, i.e.:

$$g ( r ) = \frac{4 π}{3} G {ρ}_{s} r \qquad ( 18 )$$

where G is the gravitational constant. This reveals a mathematical similarity between Lorentz force and gravity, both converging towards the geometric center and may be able to confine fusion reactions.

Consider the surface at a distance r from the centre of the 3D common focal region 140 in FIG. 1. Similar in a way to earth's surface, there are at least four points of mathematical symmetry where the four plasma beams enter/cross the surface. At each of the four points of symmetry, the net magnetic force in a plane tangential to the surface is equal to zero. Connecting any two points of symmetry along the surface with a shortest path, it may be visualized that the mid-point along the path is also a point of symmetry. This process may be repeated to generate an infinite number of symmetry points. It can be shown in this iterative process that there are no magnetic forces other than those in the radial direction. It has also been demonstrated that the distribution of the Lorentz force in the radial direction is uniform.

Integration of Equation (16) over a plasma sphere of radius R_{focal} gives its total Lorentz force, Fₜₒₜₐₗ:

$${F}_{total} = {\int }_{0}^{{R}_{focal}} \frac{3 {μ}_{0} {I}_{c}^{2} {r ( cos β )}^{2}}{2 {π}^{2} {R}_{focal}^{4}} \cdot 4 π {r}^{2} dr = \frac{3 {μ}_{0} {{I}_{c}^{2} ( cos β )}^{2}}{2 π} \qquad ( 19 )$$

Similarly, integration of Equation (18) over a massive sphere of radius Rₛ gives its total gravity, Fₘₐₛₛᵢᵥₑ:

$${F}_{massive} = {\int }_{0}^{{R}_{e}} \frac{4 π}{3} G {ρ}_{0} r \cdot 4 π {r}^{2} {ρ}_{0} dr = \frac{4 {π}^{2}}{3} G {ρ}_{0}^{2} {R}_{s}^{4} = \frac{3 {GM}_{s}^{2}}{4 {R}_{s}^{2}} \qquad ( 20 )$$

Further dimensional analysis gives the following ratio of two pressures, p_{focal} for the small plasma sphere of radius R_{focal} and pₛ for the massive sphere of radius Rₛ,

$$\frac{{p}_{focal}}{{p}_{S}} = \frac{{F}_{total} / {R}_{focal}^{2}}{{F}_{massive} / {R}_{s}^{2}} = \frac{3 {μ}_{0} {{I}_{c}^{2} ( cos β )}^{2}}{2 π {R}_{focal}^{2}} \cdot \frac{4 {R}_{s}^{4}}{3 {GM}_{s}^{2}} = \frac{2 {μ}_{0} {{I}_{c}^{2} ( cos β )}^{2} {R}_{s}^{4}}{π {R}_{focal}^{2} {GM}_{s}^{2}}$$

It is possible to modify the mathematical equations describing a stellar structure (Prialnik, 2000) using a corrected gravitational constant. Put another way, based on a mathematical equivalence between the common focal region 140 and a star, such as the Sun, equations have been developed for the focal region and solved numerically for the density, temperature, and pressure distributions that lead to a prediction of net fusion energy output. For a stellar structure, such as the Sun, the momentum equation, sometimes also referred to as the hydrostatic equilibrium equation, may be calculated as:

$$\frac{dP}{dr} = - ρ \frac{Gm}{{r}^{2}} \qquad ( 22 )$$

Considering the mathematical similarity between the Lorentz force and gravity mentioned above, a simple dimensional analysis with consideration of Equation 22 leads to:

$$\frac{{G}_{focal}}{G} = \frac{{p}_{focal}}{{p}_{S}} \cdot \frac{{R}_{focal}}{{R}_{S}} \cdot \frac{{ρ}_{S}}{{ρ}_{focal}} \cdot \frac{{M}_{S}}{{M}_{focal}} = \frac{2 {μ}_{0} {{I}_{c}^{2} ( cos β )}^{2} {R}_{S}^{3}}{π {R}_{focal} {GM}_{S} {M}_{focal}} \cdot \frac{{M}_{S} / {R}_{S}^{3}}{{M}_{focal} / {R}_{focal}^{3}} \qquad ( 23 )$$

Equation (23) may be further simplified as:

$${G}_{focal} = \frac{2 {μ}_{0} {{I}_{c}^{2} ( cos β )}^{2} {R}_{focal }^{2}}{π {M}_{focal }^{2}} \qquad ( 24 )$$

Substitution of the corrected constant described in Equation (24) into Equation (22) gives a momentum equation, which may also be referred to as a hydrostatic equilibrium equation, for the common focal region:

$$\frac{dP}{dr} = - \frac{2 {μ}_{0} {{I}_{c}^{2} ( cos β )}^{2} {R}_{focal }^{2}}{π {M}_{focal }^{2}} \frac{ρ m}{r} \qquad ( 25 )$$

Additional equations for the common focal region may be based on equations describing a stellar structure (see e.g. Prialnik, 2000) under a similar dense plasma environment. For example, a continuity equation for the common focal region may be:

$$\frac{dm}{dr} = 4 π {r}^{2} ρ \qquad ( 26 )$$

A radiative transfer equation—provided radiative diffusion constitutes the only means of energy transfer—for the common focal region may be:

$$\frac{dT}{dr} = - \frac{3}{4 ac} \cdot \frac{κρ}{{T}^{3}} \cdot \frac{F}{4 π {r}^{2}} \qquad ( 27 )$$

A thermal equilibrium equation for the common focal region may be:

$$\frac{dF}{dr} = 4 π {r}^{2} ρ q \qquad ( 28 )$$

Equations (26) to (28) may be supplemented by the following relations:

$$\begin{matrix}P = \frac{R}{{μ}_{l}} ρ T + {P}_{e} + \frac{1}{3} {aT}^{4} & ( 29 ) \\ κ = {κ}_{0} {ρ}^{a} {T}^{b} & ( 30 ) \\ q = {q}_{0} {ρ}^{m} {T}^{n} & ( 31 )\end{matrix}$$

where Equations (29) to (31) are explained as follows.

For a plasma medium formed out of heavy water vapour, the total number of ions in a unit volume is given by summation over all the ion species, i.e., deuterons and oxygen nuclei, and may be calculated as:

$${n}_{l} = {\sum }_{i} {n}_{i} = \frac{ρ}{{m}_{H}} ( \frac{{X}_{D}}{2} + \frac{{X}_{O}}{16} ) \qquad ( 32 )$$

where nᵢ is the number of ions for the i-th species, m_{H} is the mass of each nucleon, e.g., proton, and X_{D} and X_{O} are the mass volume fraction of deuterons and oxygen nuclei respectively. The mean atomic mass of the plasma medium μᵢ is defined by

$$\frac{1}{{μ}_{I}} = \frac{{X}_{D}}{2} + \frac{{X}_{O}}{16} \qquad ( 33 )$$

Following Equation (33), the value of μ_{I} is determined to be 6.6667.

Assuming that the deuterium and oxygen atoms are fully ionized in the plasma region, the average number of nucleons per free electron is μₑ=2. Such a complete ionization condition usually exists in hydrogen-depleted stars in astrophysics. Neglecting the electron degeneracy pressure (Prialnik, 2000) that exists in an extremely dense environment due to the Heisenberg uncertainty principle in quantum mechanics, the electrons can be described by the ideal gas law and the corresponding electron pressure is given by:

$${P}_{e} = \frac{R}{{μ}_{e}} ρ T \qquad ( 34 )$$

where R is the ideal gas constant with a value of 8.31451

$$\frac{kJ}{kg \cdot K} .$$

Substitution of Equation (34) into Equation (29) gives:

$$P = \frac{R}{{μ}_{I}} ρ T + \frac{R}{{μ}_{e}} ρ T + \frac{1}{3} {aT}^{4} \qquad ( 35 )$$

where the third term reflects radiation pressure with

$$a = 7.5646 \times {10}^{- 16} \frac{J}{{m}^{3} \cdot {K}^{4}} ,$$

Equations (27) and (30) describe the radiative heat transfer due to interaction between photons and matter within the plasma region. The most important interactions within a high temperature plasma region are those involving free electrons, rather than the much heavier nuclei (Prialnik, 2000), i.e.,
Electron scattering—the scattering of a photon by a free electron. This is known as Compton scattering, or in the nonrelativistic case, Thompson scattering; and
Free-free absorption—the absorption of a photon by a free electron, which makes a transition to a higher energy state that can interact with a nucleus or ion. The inverse process, leading to the emission of a photon, is known as bremsstrahlung.

The opacity coefficient K in Equation (30) can be written for each of the above two mechanisms. The opacity resulting from electron scattering is temperature and density independent, i.e., a=b=0, can be calculated as:

$${κ}_{es} = \frac{{κ}_{es , 0}}{{μ}_{e}} ( 1 + {X}_{H} ) = \frac{1}{2} {κ}_{es , 0} ( 1 + {X}_{H} ) \qquad ( 36 )$$

where κ_{es,0}=0.04 m²/kg, and X_{H} is the mass fraction of hydrogen. For the case of a heavy water plasma medium, X_{H}=0.

The opacity resulting from free-free absorption may be described by a relationship known as Kramers opacity law, with a=1 and b=−7/2, calculated as:

$${κ}_{ff} = \frac{1}{2} \times 7.5 \times {1.0}^{21} 〈 \frac{{Z}^{2}}{A} 〉 ρ {T}^{- 7 / 2} , ( {m}^{2} \text{/} kg ) \qquad ( 37 )$$

where the units for density and temperature are g/cm³ and K respectively, and:

$$〈 \frac{{Z}^{2}}{A} 〉 = {\sum }_{i} {X}_{i} \frac{{Z}_{i}^{2}}{{A}_{i}} = {X}_{D} \frac{{1}^{2}}{2} + {X}_{O} \frac{{8}^{2}}{16} = 0.1 + 3.2 = 3.3 \qquad ( 38 )$$

for heavy water composition. Combining Equations (36) and (37) gives:

κ=0.02(1+X_{H})+1.2375×10²²ρT^{-7/2}, (m²/kg) (39)

Calculation of fusion power output also requires a relationship for fusion reaction rate. As discussed further below, such a relationship has been developed for D-D reactions in a dense plasma environment, based on a quantum wave theory associated with an enhancement factor and in combination with solar information:

$$\begin{matrix}ρ q = {R}_{22} \\ = 4.518 \times {10}^{25} {( \frac{{ρ}_{deuteron}}{115.42 g \text{/} {cm}^{3}} )}^{3} {( \frac{T}{15.7 M ° K} )}^{3.5} ( W \text{/} {m}^{3} )\end{matrix} \qquad ( 40 )$$

where the deuteron density is taken to be 20% of the overall density for the plasma mixture and a slightly conservative exponent of 3.5 is used as the exponent for temperature, as compared with e.g. Equation (68) and its associated derivation discussed below. Without the enhancement factor, the current theory of reaction cross section (Clayton, D. D., 1968; Burbidge, E. M. et al., 1957) may be overly conservative. Due to the super-conducting behaviour of plasma at temperatures exceeding millions of degrees, Joule heating is neglected at the common focal region and therefore fusion is the only active mechanism of heat generation.

Equations (25) through (28) can be solved numerically together with Equations (35), (39), and (40). The following boundary conditions are applied:

m=0 at r=0 (41)

F=0 at r=0 (42)

T=T₀ at r=0 (43)

P=0 at r=R_{focal} (44)

where it is assumed that the plasma velocity T₀ is consistent with the velocity of plasma observed in naturally occurring lightning (e.g. 137 km/s). For example, a typical lightning beam velocity of 137 km/s can turn into a peak temperature of 12 MK at the common focal region of the four-beam configuration due to thermal collision of the four beams.

### Numerical Simulation

Numerical simulations were conducted to calculate expected fusion power output for the region of intersection (i.e. the common focal region) using the following input data, which was based on data for regular lightning beams observed in nature:
Fuel is heavy water in its plasma state, in the form of a plasma beam under Z-pinched conditions, similar to a natural lightning strike;
The radius of each beam and common focal region R₀=R_{focal}=5 mm;
Velocity of each beam V_{L}=137 km/s (equivalent to a peak temperature of 12 MK); and,
The applied electric current for each beam I=100,000 A.

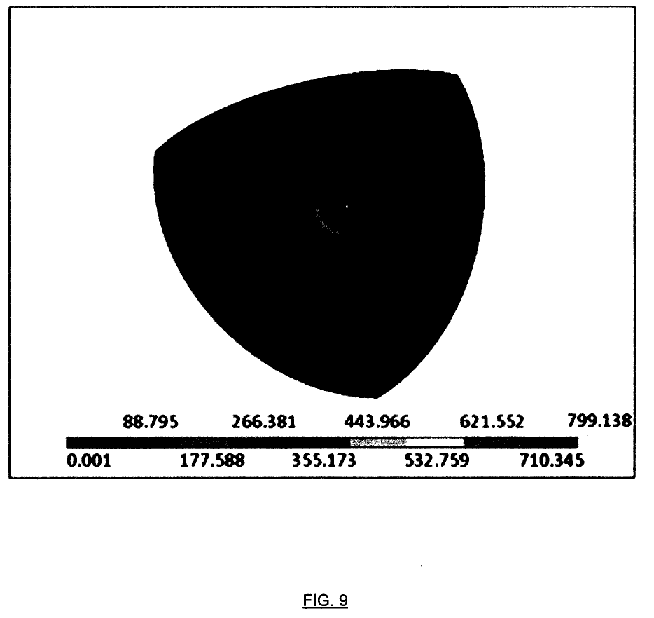

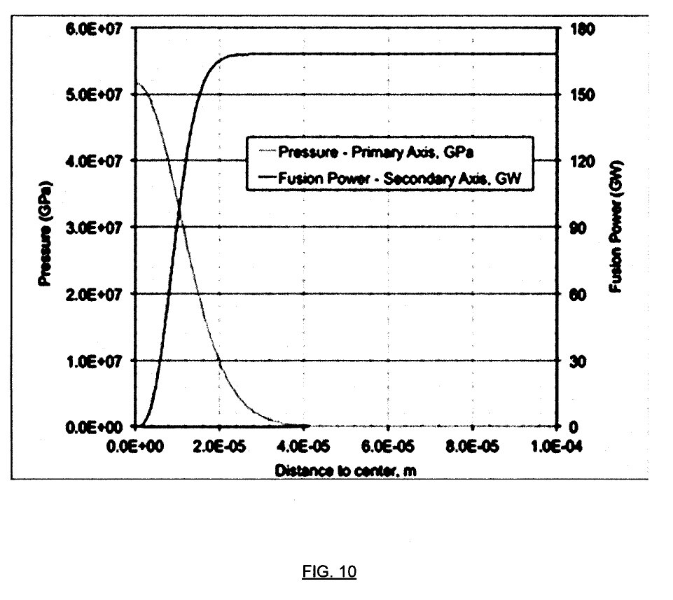

Results of these numerical simulations are shown in FIGS. 9 and 10. FIG. 9 illustrates the simulated density distribution in the radial direction for a small region within 0.1 mm from the geometric center of the focal region, or 2% of the value of R_{focal}. The peak density was calculated to be 799 g/cm³ for the common focal region, as compared to e.g. the peak density of 158 g/cm³ thought to exist at the solar core.

FIG. 10 is a plot of pressure distribution in the radial direction along with calculated fusion power output. The peak fusion power output was calculated to be 168 GW, or 840 times the estimated input power of 0.2 GW (see e.g. Equation (83)). This suggests that net energy output can be achieved with the four-beam configuration of FIG. 3.

These simulation results are also consistent with the results of other methods of calculating an estimated energy output (see e.g. Equation (81) and its associated derivation discussed below, which includes some additional simplifying assumptions, e.g. uniform temperature and density distributions assumed for the core of the common focal region).

### Verification of Numerical Simulation

As a verification case, numerical simulation was carried out for the sun in its early age using Equation (22) together with Equations (26), (27) and (28), as well as boundary conditions (41), (42), (43), and (44). Supplemental Equations (35) and (39) are also used without modifications. Instead of Equation (40) for deuteron-deuteron reactions, the following equation for proton-proton reactions is used, i.e.

$$\begin{matrix}ρ q = {R}_{11} \\ = 276.5 {( \frac{{ρ}_{proton}}{57.71 g \text{/} {cm}^{3}} )}^{3} {( \frac{T}{15.7 M ° K} )}^{3.5} ( W \text{/} {m}^{3} )\end{matrix} \qquad ( 45 )$$

The numerical results are compared with those available in literature below in

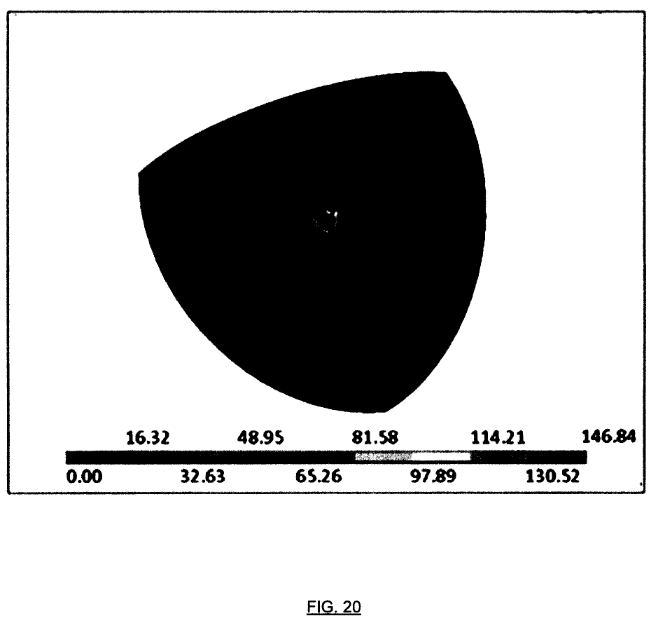

TABLE 1
The agreement is satisfactory considering that Kramers opacity law (Equation
(37)) has an accuracy of about 20%. The power density distribution in the radial
direction (W/m³) through the early sun is shown in FIG. 20.

| | | | | | | | Peak | Peak Power | |
|---|---|---|---|---|---|---|---|---|---|
| | | | | | | Solar | Density, | Density, | Total |
| | XH | T, MK | μₗ | μₑ | Radius, m | Mass, kg | g/cm3 | W/m3 | Power, W |
| Present | 0.707 | 13.7 | 1.29 | 1.17 | 6.59 × 108 | 1.86 × 1030 | 77.5 | 146.8 | 3.23 × 1026 |
| (Prialnak, | | | | | | 1.99 × 1030 | 90 | 125.1 | 2.78 × 1026 |
| 2000) | | | | | | | | | |
| (Clayton, | | | | | | | | | |
| 1968)) | | | | | | | | | |
| Difference | | | | | | −6.5% | −13.9% | 17.3% | 16.2% |

TABLE 1
Comparison of simulation results for the Sun in its early life (zero-age model)

| | | | | | | | Peak | Peak Power | |
|---|---|---|---|---|---|---|---|---|---|
| | | | | | | Solar | Density, | Density, | Total |
| | XH | T, MK | μₗ | μₑ | Radius, m | Mass, kg | g/cm3 | W/m3 | Power, W |
| Present | 0.707 | 13.7 | 1.29 | 1.17 | 6.59 × 10⁸ | 1.86 × 10³⁰ | 77.5 | 146.8 | 3.23 × 10²⁶ |
| (Prialnak, | | | | | | 1.99 × 10³⁰ | 90 | 125.1 | 2.78 × 10²⁶ |
| 2000) | | | | | | | | | |
| (Clayton, | | | | | | | | | |
| 1968)) | | | | | | | | | |
| Difference | | | | | | −6.5% | −13.9% | 17.3% | 16.2% |

### A Plasma Beam Under Z-Pinch Conditions

In an effort to obtain solution to each of the four beams supporting the focal region, Equations (25), (26), (27) and (28) are re-written for a one beam axisymmetric case. Firstly, we have the following estimation for the pressure gradient based on modification of Equation (25):

$$\frac{dP}{dr} = - \frac{4 {μ}_{0} {I}_{c}^{2} {R}_{0}^{2}}{3 π {M}_{L}^{2}} \frac{ρ {m}_{L}}{r} \qquad ( 46 )$$

where m_{L} and M_{L} are the local and total masses of the plasma beam per unit length, respectively. The factor related to cos β in Equation (25) is not relevant to this case and therefore dropped. Similarly, the factor of 3 appearing in Equation (16) is due to summation of the Lorentz forces for the four beams, and thus not applicable for this case; its absence is compensated for in Equation (46). The remaining equations are as follows

$$\begin{matrix}\frac{d {m}_{L}}{dr} = 2 π r ρ & ( 47 ) \\ \frac{d T}{dr} = - \frac{3}{4 ac} \cdot \frac{κ ρ}{{T}^{3}} \cdot \frac{{F}_{L}}{2 π r} & ( 48 ) \\ \frac{d {F}_{L}}{dr} = 2 π r ρ q & ( 49 )\end{matrix}$$

where F_{L} is the amount heat generated per unit length for a region enclosed by radius r, due to Joule heating for the plasma beam under Z-pinch conditions. Compared to the 3D spherical case, the factor of 4πr² is replaced by a factor of 2πr consistently for this axisymmetric case, including Equation (25).

For a typical plasma beam under Z-pinch conditions, for example, a natural lightning beam, the plasma temperature is usually too low for the electron and photon pressures to become significant. Applying the ideal gas law, without electron and photon pressures, Equation (29) becomes:

$$P = \frac{R}{{μ}_{I}} ρ T \qquad ( 50 )$$

The opacity coefficient for plasma temperatures in the order of 15,000 K, such as a natural lightning beam, can be dominated by a mechanism called bound-free absorption (Prialnik, 2000), i.e., the removal of an electron from an atom (ion) caused by the absorption of a photon. The inverse process is radiative recombination. A rough numerical estimation of the bound-free opacity is given below:

κ=10²⁴Z(1+X_{H})ρT^{-7/2}, (m²/kg) (51)

where for the case of a heavy-water plasma beam, X_{H}=0, and

$$Z = {\sum }_{i} {X}_{i} {Z}_{i} = 0.2 \times 1 + 0.8 \times 8 = 6.6 \qquad ( 52 )$$

Substitution of Equation (52) into Equation (51) gives

κ=6.6×10²⁴ρT^{-7/2}, (m²/kg) (53)

Instead of fusion, the thermal energy source for the one beam case is Joule heating. Consequently,

$$ρ q = \frac{V}{L} {ρ}_{I} = \frac{V}{L} \cdot \frac{I}{{M}_{L}} ρ ( W \text{/} {m}^{3} ) \qquad ( 54 )$$

where it is assumed that the current density is proportional to the plasma density based on a constant distribution of the electron drift velocity for a uniform applied electric field with a strength of V/L. The relationship set out in Equation (54) can be further refined once relevant experimental data become available.

The following boundary conditions are applied:

m_{L}=0 at r=0 (55)

F_{L=}0 at r=0 (56)

T=T₀ at r=0 (57)

P=P₀ at r=R₀=R_{focal} (58)

Equations (46), (47), (48), (49), (50), (53) and (54) can be solved numerically, together with boundary conditions (55) to (58). As an example, the following input data was used to generate a numerical solution using the above equations and boundary conditions.
Fuel is heavy water in its plasma state, in the form of a plasma beam under Z-pinched conditions, similar to a natural lightning strike;
The radius of each beam and common focal region R₀=R_{focal}=5 mm;
T₀=15,000 K for a natural lightning beam in the atmosphere, i.e., P₀=0.1 MPa.
The applied electric current for each beam I=100,000 A, and voltage V=500 V/m.

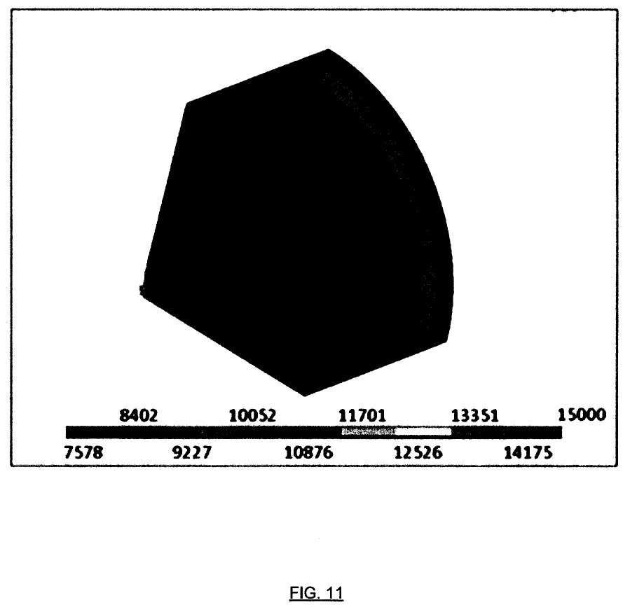

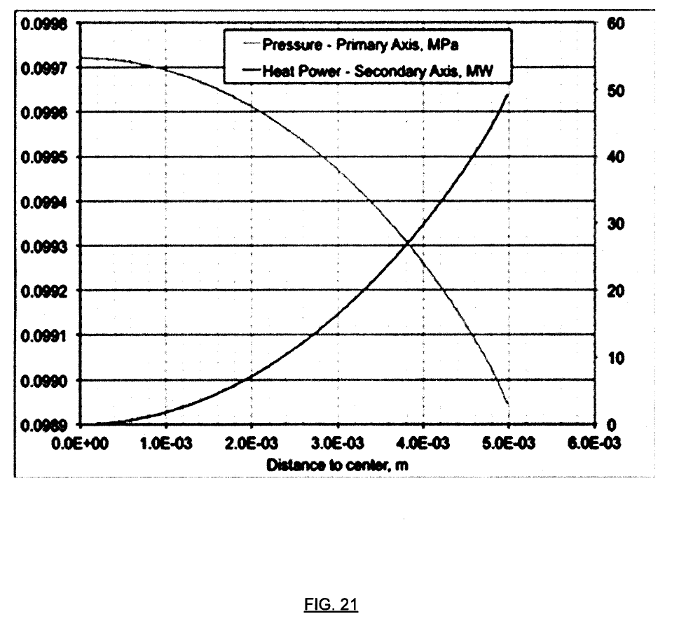

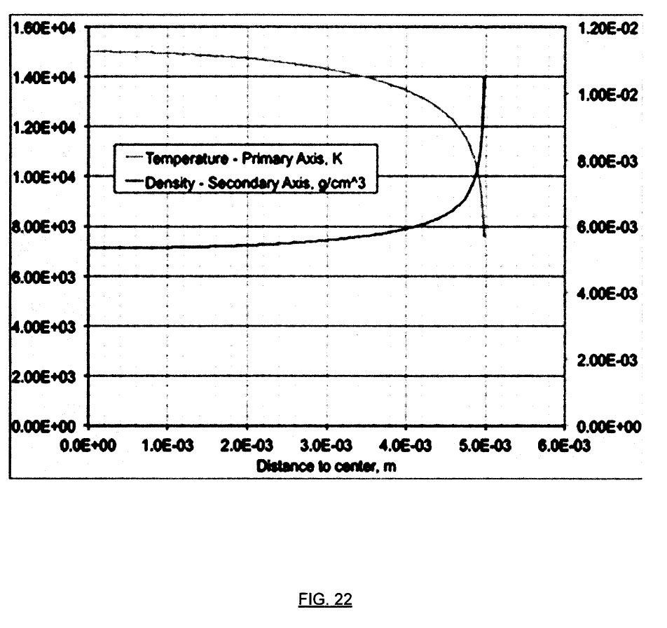

Results of these numerical simulations are shown in FIG. 11. The temperature distribution in the radial direction was calculated to include a relatively hot plasma region enclosed by a cool region near the outer surface. The pressure distribution was also calculated and found to be nearly constant, within 1% of P₀, in the entire radial direction, as shown in FIG. 21. Associated with the sharp drop in temperature near the outer surface is a significant increase in the density, as shown in FIG. 22; this is consistent with the nearly constant pressure distribution.

The integrated power output F_{L} was calculated to be a function of r, reaching a maximum of 50 MW/m at R₀, as shown in FIG. 21. This is in excellent agreement with the power input of 500 V/m by 100,000 A. For a four beam configuration with a length of 1 m for each beam, for example, the total power output equals to 4×50 MW=200 MW. Such a configuration may lead to a feasible approach to achieve a sustainable and possibly compact fusion neutron source.

### Possible Diverging Effects

In addition to the self-focusing or converging effect, in the star-pinch configuration of FIGS. 3 and 4 there may be a diverging effect due to the electro-magnetic coupling of adjacent plasma beams. For each incoming plasma beam flowing towards the geometric center, for example, there are expected to be two diverging components: i) a primary component in the direction opposite to the incoming plasma flow; and ii) a secondary component perpendicular to the flow in radially outward directions.

The primary diverging component of the Lorentz forces is expected to be overcome by the electric fields that drive the electrons and the ions, i.e., plasma fluids, to move towards and through the geometric centre. This component does not contribute to the shape and stability of the region of intersection. The secondary diverging component is expected to be zero along the four axes, due to complete cancellation of coupling effects among the four opposing plasma beams, and may be ignored in other locations.

A three-dimensional distribution of g_{L} was calculated, by summation of the Lorentz forces due to the four beams at each location of the sphere—assuming a uniform density distribution—and the results are represented in

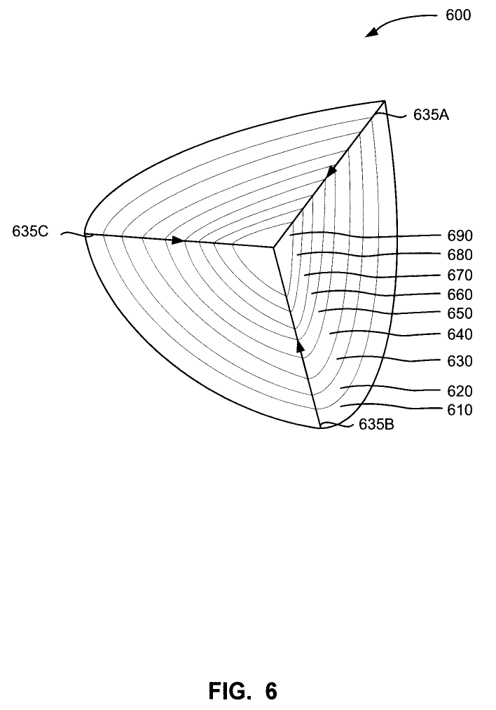

FIG. 6, where Lorentz force regions 610, 620, 630, 640, 650, 660, 670, 680, and 690 are shown for a plasma sphere 600 formed at the intersection of plasma beams 635A, 635B, 635C, and 635D (not shown; flowing directly into the page towards the intersection of beams 635A-C). The observed uniformity indicates that Equation (17) applies generically to all radial directions.

However, the distribution of converging Lorentz force shown in FIG. 6 may not be sustainable. The larger forces near the outer surface (not shown) will drive the plasma to concentrate towards in the central region of the plasma spheroid through a process known as ‘radiative collapse’ in the literature. This process may be initiated by the dynamic effects of the four plasma flows driven by electric fields through the geometric centre and stopped by one or more of these physical mechanisms: (1) Joule heating, (2) heat generated by fusion reactions, (3) quantum pressures similar to those existed in white dwarfs or neutron stars.

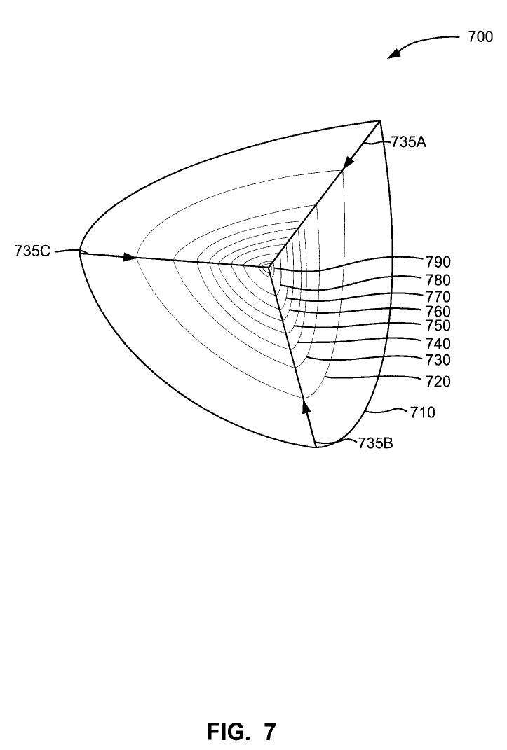

Quantitative studies of density distributions after stabilization of the radiative collapse are on-going research activities. In order to provide a qualitative view of the plasma spheroid, a density factor of 10^{4(1-r/R}₀⁾ (i.e. an exponential density factor) was applied to the Lorentz force distribution shown in FIG. 6 following information obtained from modeling of the solar core (J. Christensen-Dalsgaard, et al., 1996), with a value of 1 at the outer surface and 10,000 at the centre. An increase in density, associated with a larger pressure, must be balanced by an increasing Lorentz force. The results are represented in FIG. 7, where Lorentz force regions 710, 720, 730, 740, 750, 760, 770, 780, and 790 are shown for a plasma sphere 700 formed at the intersection of plasma beams 735A, 735B, 735C, and 735D (not shown; flowing directly into the page towards the intersection of beams 735A-C). Redistribution of plasma density as well as Lorentz force along the radial direction produces a closed wall of magnetic resistance surrounding the centre (shown in FIG. 7 at about regions 780 and 790), within which it may be possible to sustain fusion reactions in a stable furnace environment Regions 780 and 790 represent the largest converging

Lorentz force values. For example, a calculated numerical value of the dimensionless Lorentz force is relatively small (i.e. almost zero) at the outer surface (i.e. at about region 710) of the plasma sphere, and reaches a peak value (e.g. ˜1064) near regions 780 and 790, and reduces to zero at the very centre of the plasma sphere.

Possible radiative collapse at the region of four plasma beam intersection may reduce the channel cross section for each plasma beam flow, such a reduction in channel cross-section being necessarily associated with increases in plasma density, velocity, and temperature. This may, in theory, introduce a point of singularity with zero sectional areas when Joule heating, fusion reactions, and quantum pressures fail to resist the process. Applying a current density factor of (R₀/r)² due to conservation of electric charges, for example, a dimensionless form of Equation (16) becomes:

$${g}_{m}^{′} = {\frac{2 {π}^{2} {R}_{focal}^{2}}{{μ}_{0} {I}_{c}^{2}} [ {( \frac{{R}_{focal}}{r} )}^{2} ]}^{2} {f}_{m} = 3 {( cos β )}^{2} {( \frac{{R}_{focal}}{r} )}^{3} \qquad ( 59 )$$

Practically, under laboratory conditions, radiative collapse at instability locations may introduce an energy (Thonemann, P. C. et al., 1958) or density (Sinars, D. B. et al., 2003) concentration exceeding three orders of magnitude compared to the lightning strikes in nature.

### Stability and Confinement Time

Steady-state plasma flows in the four beams may be necessary for controlled release of nuclear reactions. Stability of the plasma region under the counter balancing electro-magnetic fields may be encouraged by the minimization principle of potential energy. If the plasma region is higher in one plasma beam, the radial magnetic force brings it down by doing work to minimize its potential energy. The spheroidal shape of the plasma region may therefore be maintained and its stability enhanced (if not ensured) during the radial collapse of the plasma region to eventually ignite and sustain fusion reactions. The minimization principle manifests itself during the stable gravitational collapse of hydrogen gas clouds into stars and eventually into black holes for more massive stars in interstellar space.

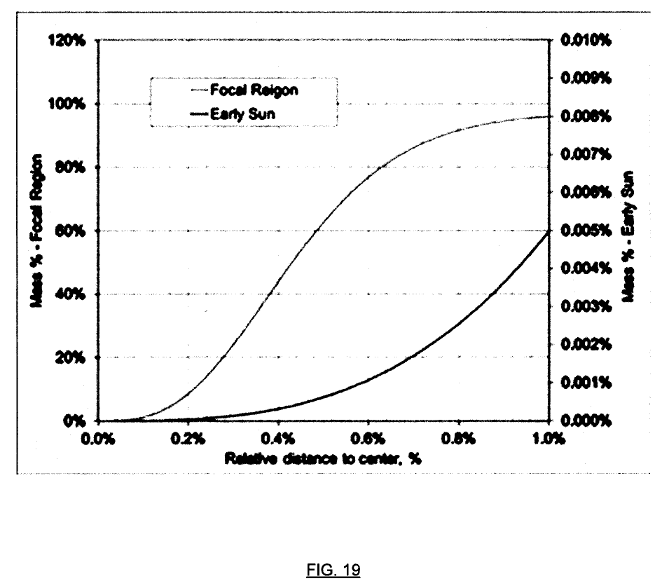

The results shown in FIG. 9, for a small region within 2% of the radius of the focal region, demonstrate that the plasma region mass is highly concentrated near the geometric center. The level of mass concentration is also illustrated in FIG. 19, where nearly 96% of the mass is concentrated within 1% of the relative distance (defined here as r/R₀) significantly exceeding the solar mass concentration. This is anticipated to have an enhancing effect for the focal region stability.

The four plasma beams supporting the common focal region are also anticipated to be sufficiently stable based on observation of natural lightning beams. In nature, this is a necessary condition in order to achieve neutralization of electric charges between clouds, or from clouds to the ground. The electrical current within a typical negative cloud-to-ground lightning discharge rises very quickly to its peak value in 1-10 μs, then decays more slowly over 50-200 μs. The natural lightning beams are therefore at least stable in the order of μs, which is many order of magnitude larger than the confinement time in the order of ps or ns achieved so far in laboratories for very dense plasma.

The results of X-pinch experiments (Sinars, D. B. et al., 2003) demonstrated that a collapse of plasma in the region of intersection occurred prior to kink and/or sausage instabilities of the two beams, likely due to the dynamic effects of plasma flows with electrons (driven by voltage supply) through the point of intersection. The X-pinches were not symmetrical in space, and as a result, a micro pinch formed in the region of intersection, which eventually lost its stability at a later stage (Sinars, D. B. et al., 2003). The four beam configuration illustrated in FIGS. 3 and 4 is anticipated to avoid this type of micro-pinch instability as a consequence of the zero vector sum of the four electric currents at the connection centre (i.e. the common focal region). The minimization principle of potential energy, which keeps a star shape spherical during its gravitation collapse, applies to the region of intersection in the four beam configuration to ensure identical plasma region dimensions in the axial directions of the four beams.

Instability issues addressed by the four beam configuration are thought to include:
Kink/sausage instabilities—such instabilities should be incompatible with the spheroidal shape of the plasma region;
Micro-pinch instability in X-pinches—such instabilities are expected to be avoided by zero vector sum of the four electric currents; and
Rayleigh—Taylor instability—such instability may be mitigated by increasing the period of the electric pulses, for example using AC currents, to minimize the particle acceleration into the plasma region.

A stable collapse of the plasma region permits a controllable and sufficiently long confinement time, which in combination with necessary temperature and density conditions may ignite/sustain fusion reactions and achieve a net energy output (Lawson, J. D., 1957). For continued operation of a fusion power plant, the confinement time should preferably exceed the pulse time, which for an AC current with a frequency of 50 Hz is 10 ms. A target confinement time of 10 ms would therefore be sufficient for continuous power generation. Such a confinement time was exceeded by tokamak machines where the confinement time was measured in the order of seconds. The stability of the four beam configuration illustrated in FIGS. 3 and 4 is expected to be comparable or better than that of tokamak machines considering the spheroidal shape of the plasma region where the minimization principle of magnetic potential energy is applicable to encourage stability. The target confinement time of 10 ms is therefore expected to be achievable.

### Nuclear Fusion Within Dense Plasma Enhanced by Quantum Particle Waves

The proton-proton (p-p) chain reaction is the fusion reactions by which stars the size of the Sun or smaller convert hydrogen into helium. According to classical laws of physics, such reactions require sufficient kinetic energy, e.g., temperature, available to overcome the Coulomb repulsion between positively charged nuclei. The temperature of the Sun was considered too low for this to occur in the 1920s (McCracken, G. and Stott, P., 2005). After the development of quantum mechanics, it was discovered that tunneling of the wave functions of the protons through the repulsive barrier allows for fusion at a lower temperature than the classical prediction (M. Kikuchi, 2010). These quantum waves of fuel particles, (e.g. protons, deuterons), could also become interconnected under the condition of sufficient plasma density to form a continuum of waves.

The following is a theory of—and also an attempt to quantify—the possible effect of such interconnected quantum waves within dense plasma on fusion reactions.

### Theory

### Assumptions

The assumptions listed below are adopted in order to quantify the rate of fusion reactions for the participating fuel particles within a dense plasma environment:
The quantum waves of fuel particles are interconnected to form a continuum of waves.
The fusion reaction rate is proportional to a penetration factor for the waves.
The wave penetration factor is proportional to the density of the participating fuel particles.
The temperature dependency relationship is as described by the current theory.

### Mathematical Relationship

In order to develop a mathematical relationship for the fusion reaction rate for dense plasma with quantum wave effects, let's first examine the density condition at the solar core. The radius of the core is about 25% of the total radius for the Sun. The density at the core is in the range of 20 g/cm³ at the edge to 150 g/cm³ at the centre (J. Christensen-Dalsgaard, et al., 1996). At these densities, the wave characteristics inherent in microscopic particles in quantum mechanics start to influence the fusion reactions in a fundamental way. For example, the quantum tunneling of wave functions of the protons through the Coulomb barrier directly facilitates the p-p fusion reactions. Without the enhancement role of the quantum particle waves, p-p reactions are not possible at the temperatures within the solar core (M. Kikuchi, 2010), i.e., 700 to 1500 MK (Clayton, D. D., 1968).

It is postulated that the quantum particle waves of the protons have become interconnected to form an ocean of the waves under the density condition within the solar core. When a fuel particle, such as a deuteron, travels within the solar core, it constantly encounters the quantum probability waves of the protons, experiencing a quantum pressure and a nonzero probability for fusion no matter where it goes. Consequently, it is a certainty for the travelling deuteron to eventually fuse with a proton, as soon as its accumulated probability of encountering the quantum waves of the protons becomes unity, i.e., when an entire proton has been experienced by the travelling deuteron.

The fusion reaction rate between fuel particles 1 and 2 is anticipated to be proportional to a penetration factor characterizing the quantum waves of the two fuel particles. Denoting the quantum probability waves of fuel particle 1 as f₁(x, y, z, t), those of fuel particle 2 as f₂ (x, y, z, t), and including a sufficient time-space to contain a large number of individual fuel particles 1 and 2 within it, the penetration factor for the quantum waves, F₁₂, may be defined as:

$${F}_{12} = \frac{1}{Δ x Δ y Δ z Δ t} {\int }_{0}^{Δ x} {\int }_{0}^{Δ y} {\int }_{0}^{Δ z} {\int }_{0}^{Δ t} {f}_{1} ( x , y , z , t ) \cdot {f}_{2} ( x , y , z , t ) dxdydzdt \qquad ( 60 )$$

where the dimension of F₁₂ is 1/m³. To maintain its physical meaning, F₁₂ has to be a real number. This requires probability wave functions f₁(x,y,z, t) and f₂ (x, y, z, t) to be complex conjugate to each other. The time t in the complex probability wave functions certainly describes the random thermal movement of the fuel particles. In addition, the inherent frequencies due to the internal energies of the nuclei of the fuel particles should be considered as required.

The fusion reaction rate F₁₂ between fuel particles 1 and 2 may be calculated as follows:

$${r}_{12} = \frac{{C}_{12}^{0} ( T ) {n}_{1} {n}_{2}}{Δ x Δ y Δ z Δ t} {\int }_{0}^{Δ x} {\int }_{0}^{Δ y} {\int }_{0}^{Δ z} {\int }_{0}^{Δ t} {f}_{1} ( x , y , z , t ) \cdot {f}_{2} ( x , y , z , t ) dxdydzdt \qquad ( 61 )$$

where the dimension of r₁₂ is 1/m³/s, n₁ and n₂ are number densities for particles 1 and 2, respectively, T is temperature, and the term C₁₂⁰(T)n₁n₂ reflects the average frequency of encounters, with a dimension of 1/s, between an arbitrary pair of fuel particles 1 and 2. C₁₂⁰(T), in m⁶/s, is a temperature dependent constant of fuel particles 1 and 2 addressing the combined effect of all the physical considerations listed below, and is anticipated to increase exponentially with T based on existing laboratory observations on fusion reaction rate:
Coulomb barrier between atomic nuclei, shielded by electrons in the plasma
Pressure due to quantum waves, a direct consequence of the uncertainty principle
Penetration depth related to Coulomb barrier, quantum pressure and T
A probability of encounter as a function of the penetration depth
Characteristic volumes for fuel particles 1 and 2
Characteristic length of penetration defining fusion between fuel particles 1 and 2
Relative velocity between fuel particles 1 and 2, and its statistical distribution

In a dense plasma environment, with the individual quantum waves interconnected to form a continuum of fuel particle waves, the average level of penetration for the quantum waves is anticipated to be proportional to an average density, \sqrt{n₁n₂}, of the participating fuel particles 1 and 2. As a result, Equation (61) may be simplified using the mathematical relationship:

r₁₂=C₁₂⁰(T)n₁n₂F₁₂=C₁₂(T)(n₁n₂)^{3/2} (62)

where C₁₂(T) is proportional to C₁₂⁰(T). For identical particles, Equation (62) becomes:

r₁₁=C₁₁⁰(T)n₁²F₁₁=C₁₁(T)(n₁)³ (63)

Equations (62) and (63) differ from the current theory (Clayton, D. D., 1968; Burbidge, E. M. et al., 1957) based on the concept of reaction cross section, in that the reaction rate is now proportional to density cubed, and not density squared. The additional density factor is derived from the penetration level for the interconnected quantum waves, characteristic of a dense plasma environment, as an enhancement factor.

The relationship between the reaction rate and temperature T remains the same as the current understanding, as the quantum waves introduced here reflect a physical concept independent of temperature T.

### Reaction-Rate Relationship

The mathematical similarity between Lorentz forces and gravity discussed above under the heading “Lorentz force distribution in radial direction”, suggests that a reaction-rate relationship derived from solar information (Clayton, D. D., 1968) may be appropriate. Limited data from the original work by Stromgrew in 1965 are listed in Table 2, where the ratio of radius/Rₛᵤₙ provides a relative location within the Sun for the fusion rate. The information on density is based on the current state of the solar modeling (J. Christensen-Dalsgaard, et al., 1996). The proton concentration by mass at the center of the Sun, currently at its mid-life, is assumed to be 37.5%, or 50% of the value of 75% (the balance as He) at the edge region of the solar core. Examination of the data on fusion rate indicates that the extent of fusion burning at the edge region of the solar core is negligible compared to the center. Consequently, the proton concentration at the edge region has been assumed to be the same as the rest of the universe, i.e., 75%.

TABLE 2
Fusion Reaction Rates at Center and Edge Region
of the Solar Core (Clayton, D. D., 1968)

| | | | Proton | | |
|---|---|---|---|---|---|
| | | | Concentration, | | Fusion |
| radius/ | | Density, | Assumed at Mid- | Proton | Rate, |
| Rₛᵤₙ | T, M°K | g/cm³ | Life of the Sun | Density, g/cm³ | Watt/m³ |
| 0 | 15.7 | 153.89 | 37.5% | 57.71 | 276.5 |
| 24% | 8.1 | 23.20 | 75.0% | 17.40 | 0.67 |
| 29% | 7.1 | 13.47 | 75.0% | 10.11 | 0.09 |

The current understanding of the fusion reactions related to hydrogen isotopes, such as D-T and D-D fusion reactions, suggests that an exponential form of T dependency is appropriate, with the exponent β in the range of 3-4 for the temperature range listed in Table 1. Considering the current theory (Clayton, D. D., 1968; Burbidge, E. M. et al., 1957), as well as the quantum wave theory proposed above under the heading “Nuclear Fusion Within Dense Plasma Enhanced by Quantum Particle Waves”, a general form of fusion reaction rate for the p-p reactions inside the Sun may be written as:

r₁₁=C₀n₁^{α}T^{β}, 3≦β≦4 (64)

where C₀ is a fuel particle constant independent of T and n₁ . The exponent α would be 2 if the current theory is applicable, or 3 if the quantum wave theory is appropriate. The value of α may be derived based on relationship (64), using the data of fusion rate listed in Table 2 for a given β. Taking two data sets 1st and 2nd, out of the three sets/rows in Table 2, α may be related to β as:

$$\frac{{r}_{11}^{1 st}}{{r}_{11}^{2 nd}} = {( \frac{{n}_{1}^{1 st}}{{n}_{1}^{2 nd}} )}^{α} {( \frac{{T}^{1 st}}{{T}^{2 nd}} )}^{β} = {( \frac{{ρ}_{proton}^{1 st}}{{ρ}_{proton}^{2 nd}} )}^{α} {( \frac{{T}^{1 st}}{{T}^{2 nd}} )}^{β} \qquad ( 65 )$$

where ρₚᵣₒₜₒₙ is the proton mass density in the solar core and the superscripts distinguish one data set from the other. The value of α as a function of β was calculated using Equation (65) and the results are listed in Table 3 for the central and edge regions of the solar core.

TABLE 3
Derived Values of α for Central and Edge Regions of the Solar Core

| α | |
|---|---|
| Central Region | Edge Region |
| 0 ≦ radius/ | 24% ≦ radius/ |
| Rₛᵤₙ ≦ 24% | Rₛᵤₙ ≦ 29% |

| β | Individual | Average | Individual | Average |
|---|---|---|---|---|
| 3.0 | 3.37 | 3.09 | 2.97 | 2.85 |
| 3.2 | 3.26 | | 2.92 | |
| 3.4 | 3.15 | | 2.87 | |
| 3.6 | 3.04 | | 2.82 | |
| 3.8 | 2.93 | | 2.77 | |
| 4.0 | 2.81 | | 2.73 | |

The derived values of α in the central and edge regions are within 5%, on average, of the theoretical value of 3 postulated above under the heading “Nuclear Fusion Within Dense Plasma Enhanced by Quantum Particle Waves”. This is remarkable considering that the fusion rate data were derived from independent modeling of the solar core. The new theory based on the concept of quantum waves has thus survived its first reality check from the Sun.

The above fusion rate results may be fitted into the following relationship within 6% accuracy:

$${R}_{11} = 276.5 {( \frac{{ρ}_{proton}}{57.71 g \text{/} {cm}^{3}} )}^{3} {( \frac{T}{15.7 M ° K} )}^{3.6} ( W \text{/} {m}^{3} ) \qquad ( 66 )$$

where R₁₁ is the fusion rate for proton-proton reactions occurring within the Sun. The above relationship differs from the current theory (Clayton, D. D., 1968; Burbidge, E. M. et al., 1957), with a density squared relationship, which assumes reaction cross section is a function of temperature independent of density. Such an assumption may not be applicable for a dense plasma environment where fuel particles may block one another's movement due to their own physical existence in the form of interconnecting quantum waves.

Equation (66) may be used to derive for practical deuteron-deuteron reaction-rate, R₂₂, considering that deuteron mass density is twice as much as proton mass density for a given number density:

$${R}_{22} = 276.5 {{f}_{deuteron} ( \frac{{ρ}_{deuteron}}{115.42 g \text{/} {cm}^{3}} )}^{3} {( \frac{T}{15.7 M ° K} )}^{3.6} ( W \text{/} {m}^{3} ) \qquad ( 67 )$$

where f_{deuteron} is an additional correction factor to account for the following:
A conversion factor of 2.14/4.01×10¹⁸ to p-D reactions (Adelberger, et al., 2011);
A second factor of 10⁶ to reflect D-D reactions, which is faster than p-D reactions (Adelberger, et al., 2011; R. Feldbacher, 1987);
A third factor of 2 to correct for the energy content, from p-p to D-D; and
A fourth factor of 3.65/23.84 to account for incomplete burning of deuterons.

The energy released by each D-D reaction is 3.65 MeV, based on average of the two known branches of D-D fusion reactions (each with 50% probability of occurrence) in human laboratories associated with intermediate products such as helium-3, tritium and neutrons. As a comparison, deuterons are fully reacted within the Sun to eventually form helium-4 (Clayton, D. D., 1968;

Burbidge, E. M. et al., 1957), with a total energy release of 23.84 MeV.

Consideration of the above correction factors leads to the following relationship for deuteron-deuteron reactions under relatively low temperatures (e.g., 6-15.7 M° K) in a dense plasma environment:

$${R}_{22} = 4.518 \times {10}^{25} {( \frac{{ρ}_{deuteron}}{115.42 g \text{/} {cm}^{3}} )}^{3} {( \frac{T}{15.7 {M }^{o} K} )}^{3.6} ( W \text{/} {m}^{3} ) \qquad ( 68 )$$

### Fusion Power Output

As an example calculation to demonstrate the value of the proposed four beam configuration, fusion power output may be calculated following a simplified analytical approach for the region of intersection using the input data listed below.
Fuel is heavy water in its plasma state, in the form of regular lightning beams.
Temperature of each beam: T₀=25,000°K.
Radius of each beam: R₀=5 mm.
Velocity of each beam: V_{L}=137 km/s.
Applied electric current for each beam: I=100,000 A.
Length of each beam: L=1 m.
Applied voltage for each beam: V_{apply}=500 V.

The above input data are consistent with regular lightning beams observed in nature. Assuming uniform distributions of density and electric charges in each plasma beam, and neglecting the term due to elastic field, the magnetic field B_{L} generated by an electric current I may be calculated by:

$${B}_{L} = \frac{{μ}_{0} I}{2 π {R}_{0}^{2}} {r}_{L} \qquad ( 69 )$$

where r_{L} is the distance to the centre of axis. Lorentz force per unit length, F_{A}, may be calculated as follows:

$${F}_{A} = {\int }_{0}^{{R}_{0}} {B}_{L} \frac{I}{π {R}_{0}^{2}} 2 π {r}_{L} {dr}_{L} = \frac{{μ}_{0} {I}^{2}}{3 π {R}_{0}} \qquad ( 70 )$$

On the other hand, the force due to pressure per unit length may be calculated by:

P_{L}=2πR₀p₀ (71)

The Lorentz and pressure forces have to be in global equilibrium, i.e.:

$$\frac{{μ}_{0} {I}^{2}}{3 π {R}_{0}} = 2 π {R}_{0} {p}_{0} \qquad ( 72 )$$

Solving Equation (72) for the pressure of the lightning beam, p₀, we have

$${p}_{0} = \frac{{μ}_{0} {I}^{2}}{6 {π }^{2} {R}_{0}^{2}} = \frac{4 π \times {10}^{- 7} \times 100 , {000}^{2}}{6 {π}^{2} \times {( 5 \times {10}^{- 3} )}^{2}} = 8.488 \times {10}^{6} ( Pa ) \qquad ( 73 )$$

The density of the lightning beam may be calculated following the ideal gas law, i.e.:

$${ρ}_{0} = \frac{{Mp}_{0}}{{R}^{′} {T}_{0}} = \frac{0.006667 \times 8.488 \times {10}^{6}}{8.31 \times 25 , 000} = 0.2724 ( kg \text{/} {m}^{3} ) \qquad ( 74 )$$

where R′ is the ideal gas constant and M is the average molar mass for the plasma formed out of heavy water vapour. The deuteron mass density, ρ_{D}⁰, is subsequently calculated to be 0.0545 kg/m³.

Consider a hot and dense core of radius R_{f} , temperature T_{f} and deuteron mass density ρ_{D}^{f}, within the common focal region, where the lightning velocity of 137 km/s is completely converted into temperature. Since the oxygen atom contributes to majority of the mass in a heavy water molecule, the lightning velocity of 137 km/s is a good approximation of the average velocity of the oxygen nuclei in the plasma mixture formed out of the heavy water vapour. With thermal equilibrium reached in the core among deuterons and oxygen nuclei, the average velocity of deuterons may be calculated by:

$${v}_{deuteron} = \sqrt{\frac{{M}_{oxygen}}{{M}_{deuteron}}} {v}_{oxygen} = \sqrt{\frac{16}{2}} \times 137 = 387.5 ( km \text{/} s ) \qquad ( 75 )$$

Equating thermal and kinetic energies gives

3/2kT_{f}=1/2m_{deuteron}v_{deuteron}² (76)

where k is the Boltzman constant. Solving Equation (76) for T_{f}, we have:

$${T}_{f} = \frac{0.002 \text{/} ( 6.02 \times {10}^{23} ) \times {( 387.5 \times {10}^{3} )}^{2}}{3 \times 1.38 \times {10}^{- 23}} 12 \times {10}^{6} ( ° K ) \qquad ( 77 )$$

Meanwhile, deuterons flow from each lightning beam and eventually squeeze into the core (assumed here to have uniform temperature and density distributions) at the velocity of 387.5 km/s. Mass conservation at a constant velocity for the four beams gives:

$${ρ}_{D}^{f} = \frac{4 \times π {R}_{0}^{2}}{{A}_{f}} {ρ}_{D}^{0} = {( \frac{{R}_{0}}{{R}_{f}} )}^{2} {ρ}_{D}^{0} \qquad ( 78 )$$

Applying Equation (68) to the core, with consideration of Equation (78), we have:

$${R}_{22} = 4.518 \times {10}^{25} {( \frac{{ρ}_{D}^{0}}{115.42 g \text{/} {cm}^{3}} )}^{3} {( \frac{{R}_{0}}{{R}_{f}} )}^{6} {( \frac{{T}_{f}}{15.7 {M}^{o} K} )}^{3.6} = 1.81 \times {10}^{6} {( \frac{{R}_{0}}{{R}_{f}} )}^{6} ( W \text{/} i \qquad ( 79 )$$

Fusion energy output P is balanced by energy loss to the environment due to radiation, i.e.:

$$P = 1.81 \times {10}^{6} {( \frac{0.005 m}{{R}_{f}} )}^{6} \times \frac{4}{3} π {R}_{f}^{3} = 5.67 \times {10}^{- 8} \times 4 π {R}_{f}^{2} \times {( 12 \times {10}^{6} )}^{4} ( W ) \qquad ( 80 )$$

Solving Equation (80) for R_{f} and P, we have

P=34×10⁹W=34GW, at R_{f}=1.52×10⁻⁶m=1.52 μm (₈₁)

Assuming a typical energy conversion rate of 30%, the net energy output may be calculated by

Pₙₑₜ=34×30%=10(GW) (82)

The calculated net energy output is equivalent to more than ten nuclear fission reactors, each with a capacity of 1 GW or less. As a comparison, the total input power for the four beams is

Pᵢₙₚᵤₜ=4×100,000×500=0.2×10⁹(W)=0.2(GW) (83)

The net energy output is thus calculated to exceed the total input power by a comfortable margin.

Recent test results (Sinars, D. B. et al., 2003; Glenzer, S. H. et al., 2012) demonstrated that the solar density condition is achievable for a plasma region. The confinement times were, however, shorter than 1 nanosecond (ns). With the improvement in stability as described above under the heading “Stability and Confinement Time”, it is anticipated that the four beam configuration may reach the solar density condition for a sufficiently long duration, e.g., 10 milliseconds (ms), suitable for commercial power generation. A significant increase in plasma density may permit utilization of diluted deuterium to satisfy the demands for fusion energy output, and a decreasing deuterium concentration within hydrogen or water may in turn promote clean hydrogen-deuterium fusion reactions occurring naturally inside the Sun.

### Proof-of-Concept Experiments

The stability of the four beam configuration, referred to as a “star-pinch”, may be demonstrated by experiments similar to those for two beam X-pinches (Sinars, D. B. et al., 2003), except that the two metal wires in a plane must be replaced with the four metal wires symmetrical in 3D space, as illustrated in FIGS. 3 and 4. The X-pinch results demonstrated satisfactory connection of two or more beams at the point of intersection, prior to formation of a micro-pinch instability (Sinars, D. B. et al., 2003). A more stable connection is expected for the four beam star-pinch. The current confinement times of plasma regions with densities approaching (Sinars, D. B. et al., 2003) or exceeding (Glenzer, S. H. et al., 2012) solid density are in the order of picoseconds (ps). A significant increase in confinement time to the order of nanoseconds (ns), for example, may be considered as initial success in the proof-of-concept by experiments. The power source used for the two beam X-pinches is an XP pulser (Kalantar, D. H., 1993) at Cornell University capable of generating a 470 kA, 100 ns current pulse. The lengths of the wires were less than an inch. The experimental setup (Sinars, D. B. et al., 2003) was relatively simple compared to those at Sandia with metal wire arrays (Haines, M. D. et al., 2006) or Livermore using laser beams (Glenzer, S. H. et al., 2012).

Hydrogen isotopes may precipitate as metal hydrides in a particular group of metals, including titanium (Williams, D. N., 1962), zirconium (Coleman, C. E. and Hardie, D., 1966), niobium (Grossbeck, M. L. and Birnbaum, H. K., 1977) and vanadium (Takano, S. and Suzuki, T., 1974). In CANDU reactors, for example, deuterium atoms from the heavy water coolant were found to diffuse into the zirconium pressure tubes to form metal hydrides (Perryman, E. C., 1978; Cann, C. D. and Sexton, E. E., 1980). Zirconium is routinely hydride or deuterided in laboratories for experiments (Simpson, L. A. and Cann, C. D., 1979). Following achievements in this area, metal hydride wires containing deuterium as fuel may be prepared as a further step to demonstrate fusion, and possibly net energy output as well, using the four beam star-pinch.

Alternatively, deuterated-polystyrene (DPS) wires were fabricated recently for use in Z-pinch experiments. Using 1 gram of DPS as the raw material, uniform DPS wires with diameters from 30 μm to 100 μm were prepared (Fu, Z. B., Qiu, L. H., Liu D. B., Li, B. and Yu, B., 2005). Recent Z-pinch experiments utilizing DPS wires produced a peak neutron yield of about 2×10⁹/cm. It is not yet clear if the neutrons were a result of D-D fusion or a phenomenon similar to the dissociation observed in the 1957 UK Zeta tests. The DPS wires may be arranged in connection with electrically conducting metal wires in the star-pinch configuration.

It is theorized that the star-pinch configuration will produce sufficient confinement time for D-D fusion. The basic elements of a test plan include:
Metal/carbon wire/filament experiments to demonstrate stability of the intersection region of the star pinch plasma beam configuration, and;
Experiments using wires/filaments containing deuterium to demonstrate fusion.

Successful tests may lead to further tests using fluids (argon, air, deuterium and/or water) as plasma media, eventually moving towards an experimental pilot.

### Power Generation

A thermonuclear reaction system 100 may operate using one or more types of suitable thermonuclear fuel particles as part of one or more known fusion reaction paths. For example, thermonuclear reaction system 100 may use deuterium, tritium, and lithium to effect a deuterium-tritium reaction cycle, as discussed above. In some embodiments, thermonuclear reaction system 100 uses a combination of ₁¹H and ₁²D in order to effect a proton-proton fusion cycle, also discussed above. While ₁²D is the primary source of energy in a proton-proton fusion cycle, ₁¹H particles are employed to produce a sufficient quantity of the intermediate product ₂²He with the participation of ₁²D, although as discussed above ₁¹H may also be converted to ₁²D in a slow process due to the effects of quantum tunneling and weak interactions.

The supply of ₁¹H and ₁²D thermonuclear fuel particles for such a proton-proton reaction is virtually inexhaustible, as approximately one in every 6,500 hydrogen atoms on Earth is a deuterium atom, and both ₁¹H and ₁²D may be readily extracted from seawater. One gallon of seawater would, in some embodiments, provide the equivalent energy output of approximately 300 gallons of gasoline.

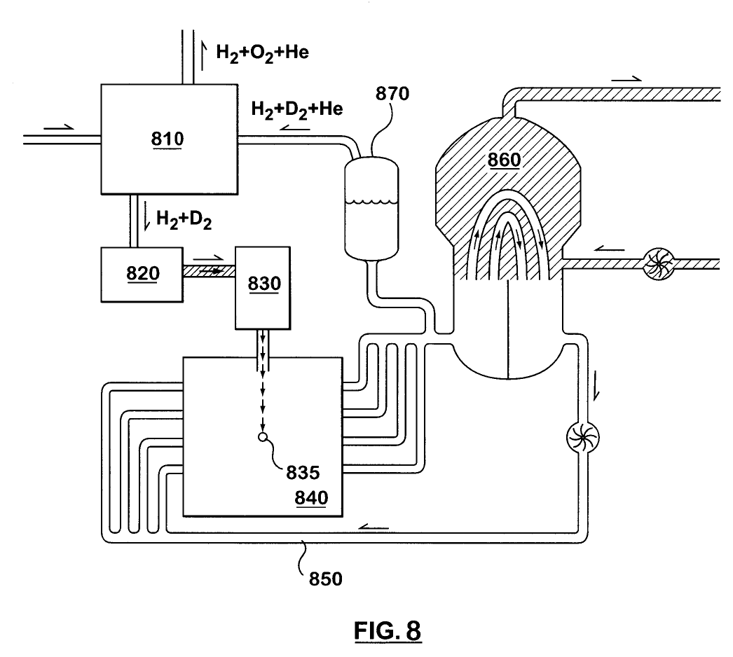

Referring now to FIG. 8, a schematic view of a thermonuclear reaction system integrated with an existing nuclear fission reactor design (such as the CANDU design) is illustrated in accordance with at least one embodiment. In this example embodiment, a continuous proton-proton fusion reaction is generated in a thermonuclear reaction system (such as the thermonuclear reaction system 100 shown in FIG. 1), and hydrogen and deuterium thermonuclear fuel particles are extracted from seawater in a separation facility 810.

After the removal of impurities, seawater containing deuterated water (sometimes referred to as HDO) and H₂O enters a separation facility 810, where ₁¹H and ₁²D are separated from O₂. The ₁¹H and ₁²D gases produced by separation facility 810 subsequently enter a fuel injector 820 (which may be similar or equivalent to fuel injector 120 as described herein above with reference to FIG. 1) where the ₁¹H and ₁²D gases are heated to form a plasma of thermonuclear fuel particles to be provided to one or more particle beam emitters 830 (which may be similar or equivalent to particle beam emitter 200 as described herein above with reference to FIG. 2).

As described above, particle beam emitters 830 may emit particle beams consisting of thermonuclear fuel particles towards a common focal region 835 of a reaction chamber 840, creating density and temperature conditions sufficient to instigate and, in at least some cases, sustain a continuous (or pseudo continuums) thermonuclear fusion reaction.

A primary cooling system 850 uses water (or any other suitable coolant liquid) to absorb at least some of the heat generated by the thermonuclear fusion reaction taking place within reaction chamber 840. Primary cooling system 850 is also connected to one or more steam generators 860; steam output from steam generator 860 may be used to drive turbines and generators (not shown) to produce electricity.

Integration with an existing nuclear reactor design may minimize the duration for design and manufacturing of an overall fusion reactor. For example, the existing CANDU reactor may be modified in accordance with embodiments of the present thermonuclear reaction system by substituting the Calandria fission reactor core with a fusion reaction chamber, removing the fuel bundles and fuelling machines, replacing the fuel channel assemblies with simple pressure tubes, installing particle beam emitters surrounding the fusion chamber, replacing the heavy water used in the CANDU design with regular water (as no neutrons need to be moderated), replacing the heavy water pressure reservoir with a gas collection tank 870, and adding the separation facility 810.

Gas collection tank 870 is used to collect un-reacted thermonuclear fuel particles and fusion reaction products, as not all of the ₁¹H and ₁²D particles injected into the reaction chamber may undergo a fusion reaction with another reactant particle. In some embodiments, the gas collection tank 870 may operate based on the relative buoyancies of different fuel particles. For example, there is a relatively large difference in density between the reactant fuel particles in a thermonuclear reaction (e.g., the ₁¹H and ₁²D particles) and the product particles of the fusion reaction (e.g., He particles), on the one hand, and the coolant fluid, on the other hand. Accordingly, the lighter gas particles will generally flow up through the coolant fluid due to buoyancy effects, resulting in a concentration of the lighter gas particles at an upper portion of the gas collection tank 870. The relatively heavy coolant fluid will correspondingly concentrate toward the lower portion of the gas collection tank 870.

In order to separate the lighter gas particles from the heavier liquid coolant, the gas collection tank 870 may include an outlet valve or other external feed in the upper portion through which the gas may be continually pumped. As the lighter gases exist as a mixture with the coolant fluid flowing through the primary cooling system, some of the gases may remain un-collected after one cycle of the coolant fluid through the primary cooling system. However, un-collected gases may eventually be collected by the gas collection tank 870 as the coolant liquid is continually pumped through the primary cooling system during additional cycles.

The un-reacted gases and fusion product collected in gas collection tank 870 may then be delivered to separation facility 810 for reuse. In addition to the un-reacted gasses and the fusion product, a small amount of coolant water close to the central region may dissociate into H₂, D₂ and O₂ due to the heat generated by a thermonuclear fusion reaction taking place within reaction chamber 840. If coolant water dissociates into H₂, D₂ and O₂, the H₂, D₂ and O₂ will be collected in gas collection tank 870 and moved to separation facility 810, following the similar path as H₂, D₂ and He gases shown in FIG. 8.

In some embodiments, the gas collection tank 870 may be modified by installation of at least one pressure valve in order to achieve an added functionality, i.e., coolant water pressure reservoir. This modification to the gas collection tank 870 would permit the gas collection tank 870 to control and achieve a desired level of pressure for the coolant liquid being pumped through the primary cooling system.

In order to maintain a desired level of ₁²D concentration in the fuel particle circulation, for optimal performance of the thermonuclear reaction system, certain amount of ₁¹H gas may be moved out of separation facility 810, along with the O₂ and He gases. The desired level of ₁²D concentration may be determined by detailed design calculations; the higher the ₁²D concentration, the larger the fusion energy output of the thermonuclear reaction system.

In some embodiments, un-reacted fuel particles collected from the gas collection tank 870 may be mixed together with newly supplied fuel particles of the same or a different type in a closed loop circulation. For example, particles of Hydrogen-1 or a mixture of Hydrogen-1 and Hydrogen-2 collected from the gas collection tank 870 may be mixed together with a new supply of Hydrogen-1 or a mixture, of Hydrogen-1 and Hydrogen-2. However, this example is not limiting. The resulting closed loop circulation of collected and new fuel particles may include one or more separation facilities (e.g., separation facility 810 in FIG. 8), one or more fuel injectors (e.g., fuel injector 120 in FIG. 1) and a plurality of particle beam emitters (e.g., particle beam emitter 200 in FIG. 2). The minimum operating temperature in the closed loop circulation may be maintained at 1800° C. or greater by the heat generated from thermonuclear fusion reactions occurring within the reaction chamber 110 as described herein. As a result, the fuel particles used to drive the thermonuclear fusion reactions are maintained essentially continuously in a plasma state without having to re-heat the fuel particles into plasma in the fuel injector prior to supplying the fuel particles to the particle beam emitter for re-emission in the reaction chamber 110.

As discussed above, thermonuclear reaction system 100 preferably uses a combination of ₁¹H and ₁²D in order to effect a proton-proton fusion cycle. However, future generations of nuclear fusion reactors, may also be able to employ other elements—such as isotopes of He, B, Li, C, Ne, O, etc.—as thermonuclear fuel. In theory, a series of fusion reactions may be designed in order to maximize the energy output from a fusion reaction path (For example, a fusion reaction could be designed with the fusion path H→He→C→Ne→O→Si).

In some embodiments, seawater may be purified to remove sand, salt or other impurities and provided, through at least one fuel injector, to some or all of the particle beam emitters 200 shown in reference to FIG. 2 as a source of thermonuclear fuel. The purified seawater may be heated up in the at least one fuel injector or subsequently in the particle beam emitters. Heating of the purified seawater causes the water molecules to dissociate into O₂, H₂ and D₂ gases and, with a sufficiently hot source of heat, at least some part of the H₂ and D₂ gases further turn into plasma due to increasing temperature. Accordingly, in some embodiments, the purified seawater is automatically separated into different thermonuclear fuel types by heating inside the at least one fuel injector or subsequently inside at least some of the particle beam emitters 200. Consequently no additional separation facilities will be needed in at least some cases to provide the thermonuclear fuel used in the thermonuclear reaction system 100.

In some embodiments, regular water, containing 0.01% of deuterium particles and becoming plasma mixture of oxygen and hydrogen isotopes inside the fusion chamber, are used as fuel for the fusion reaction. In other embodiments, regular water enriched by heavy water is used in order to increase fusion power. The level of heavy water concentration determines the level of fusion power generation, the higher the heavy water concentration, the higher the deuterium particle concentration, and therefore the larger the energy output. The oxygen particles are used in these embodiments in order to (1) contain hydrogen isotopes in liquid form under low temperatures for easy handling and (2) enforce effective collisions and therefore fusion of the hydrogen isotopes in the focal region of the fusion chamber as resistive walls consisting of heavy nuclei.

In some embodiments, heavy elements (such as oxygen in water, nitrogen in air, Na/Cl in ocean water or metal elements) are added in order to accelerate the fusion reaction as catalysts, by acting as resistive walls to enforce effective thermal collisions in the common focal region.

Through the symmetrical four beam ‘star-pinch’ configuration, plasma instabilities may be addressed, and nuclear fusion may be demonstrated using wires containing deuterium. This is supported by the following:
The counter-balancing electro-magnetic fields in the star pinch configuration will stabilize the intersection region, providing longer confinement times;
The converging magnetic forces will provide stability and density, in a manner similar to the stability achieved during star formation under gravitational forces;
Necessary density and temperature conditions, e.g., solar conditions, have already been achieved by other researchers following Z-pinch and laser beam approaches; and
A confinement time of 10 ms to achieve continuous fusion has been exceeded by tokamak;

With the potential improvement in plasma stability—and therefore its confinement time, density and temperature—the four beam star-pinch configuration may potentially lead to continuous fusion power from water without the need for tritium in the fuel.

### Neutron Yield

An example above calculated the fusion power output from the proposed four beam configuration as being 34 GW (see e.g. Equation (81)). Meanwhile the input power was calculated in Equation (83) to be 200 MW. The corresponding D-D fusion neutron yield can be calculated as follows,

$${I}_{neutron}^{DD} = \frac{34 GW}{7.3 MeV} = \frac{34 \times {10}^{9} J \text{/} s}{1.1696 \times {10}^{- 12} J} = 2.9 \times {10}^{22} \text{/} s \qquad ( 84 )$$

where 1 eV equals to 1.6022×10⁻¹⁹ Joule. The above neutron yield is consistent with a constant supply of large DC power.

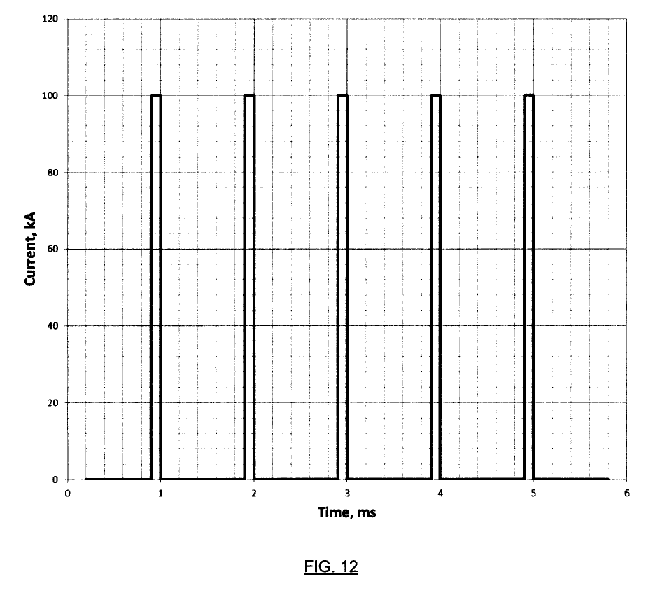

FIG. 12 illustrates an exemplary pulsed current that may be used to reduce the neutron yield. A pulsed current may be uniform, comprising a uniform peak amplitude, a uniform pulse width, and a uniform separation period between sequential pulses. The pulsed current shown in FIG. 12 has a peak of 100 kA, a pulse width of 100 μs, and a separation period of 1 ms and can reduce the neutron yield by a factor of 10 to

$${I}_{neutron}^{pulsed} = \frac{2.9 \times {10}^{22} \text{/} s}{10} = 2.9 \times {10}^{21} \text{/} s \qquad ( 85 )$$

The corresponding input power is 20 MW (i.e. 1/10^{th} of the input power calculated in Equation (83)), or 5 MW for each of four lightning beams in embodiments where a four-beam configuration is used. The use of pulsed current may also relieve some challenges related to severe thermal loads on electrodes.

In some embodiments, a minimum electric current may be applied between adjacent pulses in order to maintain connection of a plasma beam at all times, for sustaining stable and continuous or quasi-continuous nuclear fusion reactions inside the common focal region.

In other embodiments, such a minimum electric current to maintain connection of a plasma beam at all times may not be required because the plasma channel remains sufficiently hot between adjacent pulses to conduct electricity. As well, re-connection of the plasma beam may occur naturally in the subsequent pulses.

### Application Example

### Conversion of U-238 into Nuclear Fuel

This example application proposes a general framework for the conversion of U-238 and Th-232 utilizing fusion-produced neutrons. Although emerging fusion technologies may not produce sufficient net energy output to justify stand-alone applications, they may be commercially viable for breeder transmutation or hybrid fusion-fission reactor concepts proposed herein to dispose of nuclear wastes and long life high radioactive fission products remaining in shutdown nuclear power plants. Results show that such reactors could be achievable, given an appropriate fusion source.

### Neutron Capture by U-238

In a typical operating nuclear reactor containing U-238, some plutonium-239 will accumulate in the nuclear fuel due to continuous neutron capture by U-238 followed by two-beta decays, i.e.,

₉₂²³⁸U+₀¹n→₉₂²³⁹U→₉₃²³⁹Np→₉₄²³⁹Pu (86)

Plutonium present in reactor fuel can absorb neutrons and fission, similar with U-235. Fission of plutonium-239 provides about one-third of the total energy produced in a typical commercial nuclear power plant. Spent nuclear fuel commonly contains about 0.8% of plutonium-239. This compares with 0.9% of U-235 and suggests that the fission reaction rate for plutonium-239 is approximately 10% faster than that of U-235 in a typical commercial thermal nuclear reactor.

Considering light water reactors, U-235 is enriched to approximately 3%, where 2.1% of it is burned during reactor operation. This suggests that 1.05% of plutonium-239 is burned during reactor operation (one-half of 2.1% and one-third of the total). Therefore, a light water reactor generates 1.85% (0.8%+1.05%) plutonium during reactor operation. Considering one U-238 absorbs a neutron and after two-beta decays results in plutonium-239, the neutron capture rate of U-238 is calculated to be nearly 90% of the fission rate for U-235, largely due to the high concentration of U-238 (>95% of the loading uranium fuel).

During normal reactor operation, a U-235 nucleus continuously absorbs a thermalized neutron and releases on average 2.43 neutrons. One of these neutrons is typically used to split another U-235 nucleus (after moderation to thermal neutron) in order to sustain a chain reaction. Of the remaining 1.43 neutrons, as noted in the preceding paragraph, the neutron capture rate of U-238 (to become plutonium-239) is 90% of the fission rate for U-235. Thus, about 0.9 neutrons are captured by U-238 (to breed plutonium-239). The remaining 0.53 neutrons (as 2.43−1.0−0.9=0.53) are lost in the environment, e.g. neutron absorption in water, reactor components, concrete building elements, etc.

### A Pure Converter Concept

A pure converter may be designed to only convert U-238 existing within nuclear waste (>95%) into nuclear fuel, without the need to generate power. The advantages of such a simple converter include, but not limited to, operation in the temperature range between 0° C. to 100° C. and under atmosphere pressure. This may remove many engineering challenges for the design of a hybrid fusion/fission reactor and thus permit designers to focus on the issues related to conversion, for example, component material embrittlement due to neutron flux as well as irradiation damage such as voids, bubbles, cracks, etc.

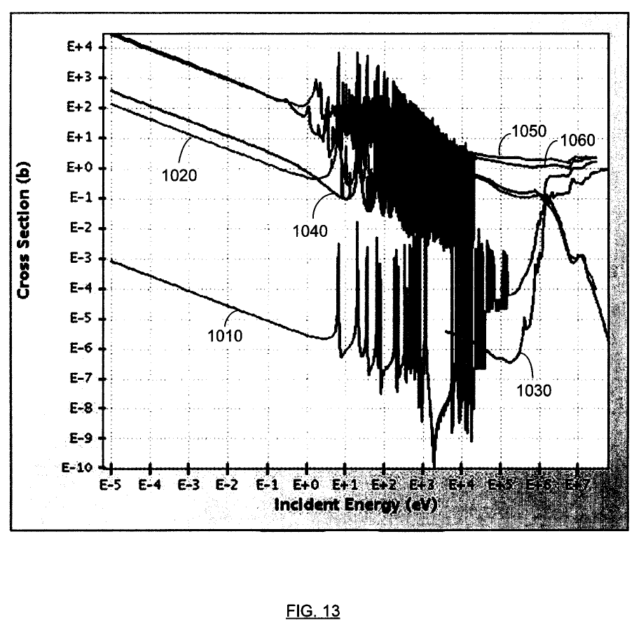

In order to maximize the conversion rate of turning U-238 into plutonium-239, the converter may be designed to work in the intermediate neutron energy range i.e., the resonance absorption peaked domain. FIG. 13 illustrates fission and neutron absorption cross-sections of selected uranium and thorium isotopes. The fission or neutron absorption cross-section relates to the probability that fission or neutron absorption will occur. The incident neutron energy relates to the speed at which neutrons travel. The probability that fission or neutron absorption will occur depends on the speed at which neutrons travel. The resonance absorption peaked domain occurs where the incident energy is 10 to 1000 eV.

The U-238 neutron absorption rate 1020 is greatly enhanced at the resonance absorption peaked domain (e.g. where the incident energy is 10 to 1000 eV) when compared to the current operating region of fission reactors (e.g., 1 eV). For example, in some parts of the resonance absorption peaked domain the U-238 neutron absorption rate is at least ten times greater than the rate at e.g. 1 eV. Meanwhile, the fission rate for U-235 (1060 in FIG. 13) and plutonium-239 (not shown, but similar to U-233, labeled 1050 in FIG. 13) may be reduced by at least 50% when compared to the current operating region of fission reactors (e.g., ˜1 eV), as without a significant resonance effect, the fission cross sections for U-235 and P-239 usually decrease with increasing neutron energy. Consequently, it is anticipated that >90% of the neutrons output by the neutron source can be used for converting U-238 into plutonium-239, based on the following estimation: 9 neutrons for conversion (i.e. 0.9 neutrons captured by U-238 (to breed plutonium-239) as calculated above in paragraph [00276], increased by a factor of 10 due to the converter operating in the resonance absorption peaked domain); 0.5 neutrons lost to the environment (e.g. the 0.53 neutrons calculated above in paragraph [00276] as being lost to the environment e.g. neutron absorption in water, reactor components, concrete building elements, etc., which are not affected as the environmental materials do not have an equivalent resonance absorption peaked domain); and 0.5 neutrons for splitting fissile fuel nuclei into two (i.e. 1 neutron used to split another U-235 nucleus (after moderation to thermal neutron) in order to sustain a chain reaction as calculated above in paragraph [00276], decreased by a factor of 2 due to the converter operating in the resonance absorption peaked domain, and as the fission cross sections for U-235 and P-239 usually decrease with increasing neutron energy).

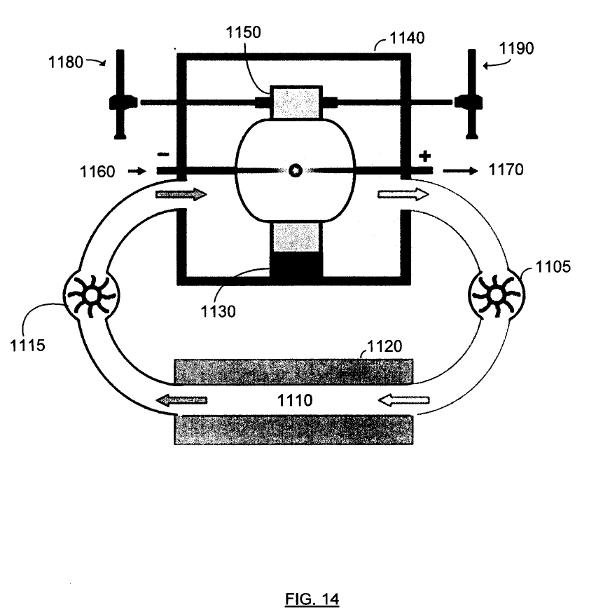

Referring now to FIG. 14, a schematic view of a pure converter concept is illustrated in accordance with at least one embodiment. The thermonuclear fusion reaction takes place within the reaction chamber that is lined with a neutron reflector 1150 to reflect neutrons and consequently contain them inside the fusion chamber to reduce neutron loss in the form of either absorption or penetration. The reaction chamber is also supported by a honeycomb shell support 1130. A supply of thermonuclear fuel particles 1160 enters the reaction chamber for use by a thermonuclear reaction system (e.g. thermonuclear reaction system 100). The by-products of the fusion reaction 1170 are preferably removed from the reaction chamber.

Material to be converted (e.g. U-238) may be fed to a honeycomb-shaped structure inside neutron reflector 1150 from a feed source 1180 and removed using a removal apparatus 1190. Fuelling machine 1180 is configured to supply the reactor with, e.g. U-238. Fuelling machine 1190 is configured to remove the converted fuel, e.g. plutonium-239. In some embodiments, this may permit material to be converted continuously (or pseudo-continuously), e.g. by introducing and removing material to be converted to/from the honeycomb-shaped structure inside neutron reflector 1150 during operation of the thermonuclear reaction system.

The reaction chamber may be contained in a coolant tank 1140. Coolant 1110 in the coolant tank 1140 absorbs at least some of the heat generated by the thermonuclear fusion reaction taking place within the reaction chamber. Pump 1105 circulates coolant 1110 from the coolant tank 1140 to a large pool 1120 where it is cooled (e.g. to near 0° C.). Pump 1115 circulates coolant 1110 from the large pool 1120 back to the coolant tank 1140 to further absorb at least some heat generated by the thermonuclear fusion reaction. While only one pump is shown for 1105 and 1115, it will be appreciated that additional pumps may be included. As well, one or more additional coolant flow paths may be provided.

### Generation of Gaseous Fusion Products

The fusion neutron yield calculated in Equation (85) is based on the application of the pulsed current shown in FIG. 12 and a thermal power output of 3.4 GW. Considering an energy conversion rate of 30%, the corresponding net electric energy output is approximately 1 GW.

Deuterium-deuterium fusion reactions will generate gaseous fusion products 1170 (i.e. tritium and heilium-3) in accordance with Equations (6) and (7). The daily gas collections are calculated as follows,

Mₕₑₗᵢᵤₘ₋₃^{day}=Mₜᵣᵢₜᵢᵤₘ^{day}=24×3600×2.9×10²¹×3×1.66×10⁻²⁷ kg=1.25 kg (87)

The dense plasma D-D fusion process described above is expected to immediately burn some of the resulting tritium and helium-3 nuclei. The remaining tritium and helium-3 that is not immediately burned may be collected and stored in tanks for future usage with other fusion approaches such as D-T or advanced D-He3 fusion (Deng, B. Q., 2013). D-T fusion will generate neutrons with 14.1 MeV energy, which is suitable for transmutation of nuclear waste.

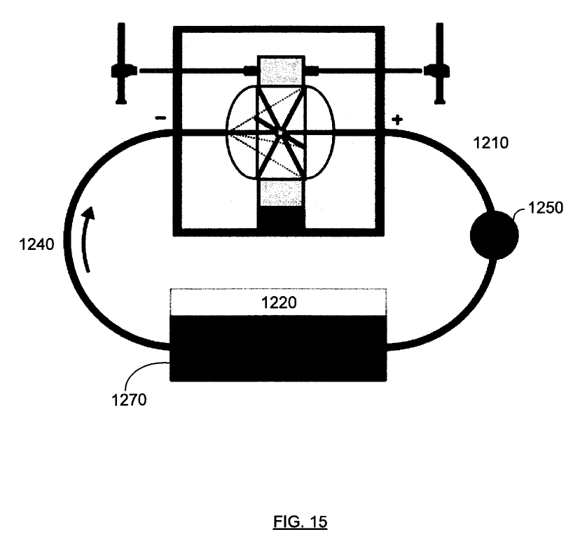

Referring now to FIG. 15, a gas collection system for the pure converter is illustrated. One or more pumps 1250 are used to remove the fusion products 1210 of the fusion reaction from the reaction chamber. The fusion product 1210 comprises heavy water, tritium water, helium-3, helium-4, and regular water. The fusion product 1210 is circulated to a gas separation tank 1270, which is similar to the gas collection tank 870 described above. In the gas collection tank 1270, helium-3, helium-4, and steam 1220 are separated from heavy water and tritium water 1230. Heavy water and tritium water 1230 circulate back into the fusion chamber to serve as fuel 1240 for additional fusion reactions. The flow of heavy water and tritium water 1230 into the fusion chamber may use one or more additional pumps (not shown). While only one pump 1250 and one gas collection tank 1270 is explicitly shown, it will be appreciated that additional pumps and tanks may be included. As well, one or more additional gas flow paths may be provided.

Considering Equations (6) and (7), as well as a fuel conversion rate of 90%, the net electric power conversion rate for one operating converter is calculated as

$$R = \frac{1 GW}{7.3 MeV} \times 90 \% \times 200 MeV = 24.66 GW \qquad ( 88 )$$

where a converted plutonium-239 atom can release a fission energy of 200 MeV.

In order to demonstrate how rapidly a converter can convert nuclear waste into nuclear fuel, let us consider an example based on the Pickering nuclear reactors in Ontario, Canada. The Pickering nuclear reactors have a net capacity of 4.12 GW based on eight reactor units (although only six reactor units are currently running). By 2014, Pickering has been operating for an average of 37 years, with four units at stations A starting in 1971 and four units at station B starting 1983. The number of years required for one converter to convert the nuclear waste accumulated at the Pickering site is calculated as follows:

$$Y = \frac{4.12 GW}{24.66 GW} \times 37 years = 6 years \qquad ( 89 )$$

FIG. 13 illustrates how the neutron capture rate for thorium-232 (plotted at 1040) is similar to that of uranium-238 (plotted at 1020). Consequently, a pure converter can also absorb a neutron and convert thorium-232 into uranium-233 (fissile material) (plotted at 1050), i.e.,

₉₀²³²Th+₀¹n→₉₀²³³Th→₉₁²³³Pa→₉₂²³³U (90)

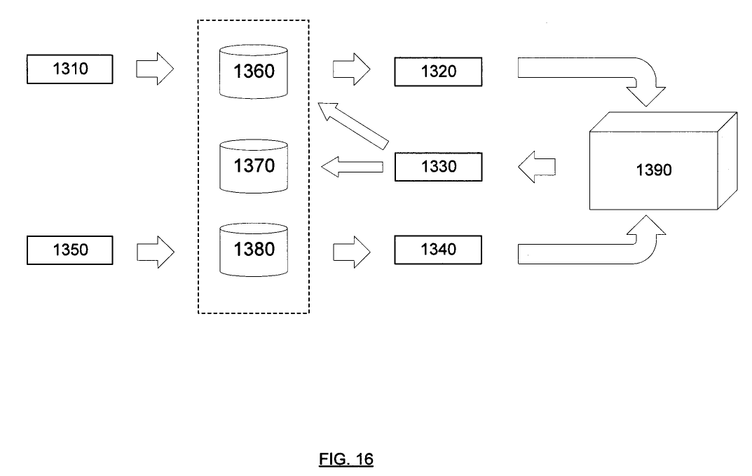

Referring now to FIG. 16, a schematic view of a nuclear fuel cycle is illustrated (Xiao Min, 2013). The fuel cycle begins with the use of lightly enriched uranium 1310 as fuel in pressurized water reactors (PWR) 1360. Lightly enriched uranium 1310 contains 3.7% to 5.0% U-235. After use, PWR used fuel 1320 contains approximately 0.9% U-235 and about 0.6%-0.8% plutonium-239. PWR used fuel 1320 is removed from PWRs 1360 and may be transferred to a reprocessing plant 1390.

PWR used fuel 1320 may be reprocessed to produce mixed-oxide fuel 1330 containing (U,Pu)O₂. Mixed-oxide fuel may be used in PWRs 1360 or fast breeder reactors 1370.

PWR used fuel 1320 may also be reprocessed to produce a natural uranium equivalent fuel 1340. Natural uranium equivalent fuel 1340 corresponds to 0.71% natural uranium and may be used in CANDU® reactors 1380, such as those at Qinshan nuclear site. The natural uranium equivalent fuel 1340 may be recycled uranium containing 0.9% U-235 or it may be a mix of recycled uranium and depleted uranium. After use, CANDU® used fuel 1350 contains 0.27% U-235 and 0.35% plutonium-239. In this fuel cycle, CANDU® used fuel 1350 represents the end of the fuel cycle.

The converter concept presented here may be a suitable candidate to close the loop of the fuel cycle illustrated in FIG. 16. For example, the CANDU® used fuel 1350 may be converted to become fuel 1310 for PWR reactors 1360.

### Breeder and Hybrid Reactors

A breeder reactor can convert fertile material, such as U-238 and thorium-232, as fast as it burns fissile material, such as plutonium-239 and U-233, during reactor operation.

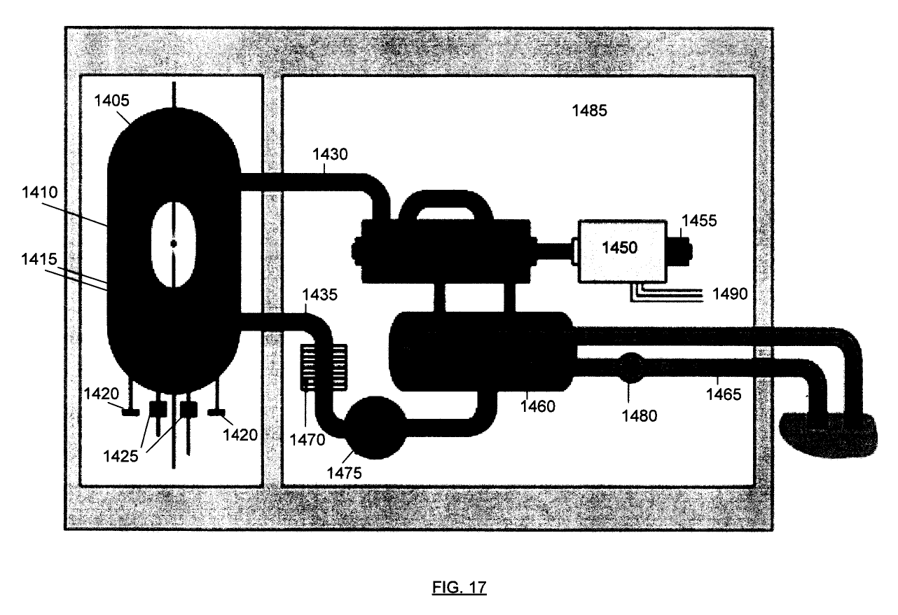

Referring now to FIG. 17, a possible breeder reactor based on a modified boiling water reactor is illustrated. The breeder reactor comprises a reactor vessel 1405, fuel chamber 1410, control rod elements 1415, circulation pumps 1420, control rod motors 1425, steam 1430, inlet circulation water 1435, high pressure turbine 1440, low pressure turbine 1445, electric generator 1450, electrical generator exciter 1455, steam condenser 1460, cold water from the condenser 1465, pre-warmer 1470, water circulation pump 1475, condenser cold water pump 1480, concrete chamber 1485, and connection to the electricity grid 1490.

In this example embodiment, a thermonuclear fusion reaction system (e.g. thermonuclear reaction system 100) is positioned in a fuel chamber 1410. Control rod motors 1425 are configured to operate control rod elements 1415. Control rod elements control the rate at which fission reactions take place in the fuel chamber 1410. While only two control rod motors and two control rod elements are shown, additional control rod motors and control rod elements may be used.

Circulation pump 1420 maintains flow of circulation water 1435 in the reactor vessel 1405. Circulation water 1435 absorbs heat generated from the fusion/fission hybrid reactions. Heat from the nuclear reactions eventually causes circulation water 1435 to boil and become steam 1430. Steam 1430 output from the reactor vessel 1405 enters the high pressure turbine 1440 and the low pressure turbine 1445. Steam 1430 causes the high pressure turbine 1440 and the low pressure turbine 1445 to spin. The high pressure turbine 1440 and the low pressure turbine 1445 are coupled to the electrical generator 1450, causing it to rotate and generate electricity. Electricity from the electrical generator 1450 is transmitted to the electricity grid 1490.

Steam 1430 output from the low pressure turbine 1445 enters the steam condenser 1460. A condenser cooling pump 1480 causes cold water 1465 to pass through the steam condenser 1460 in order to absorb the heat from the steam. Cooled steam collects in the steam condenser 1460 and becomes liquid. Water circulation pump 1475 pushes water back into the reactor vessel 1405.

Before returning to the reactor vessel 1405, the temperature of the water is raised by pre-warmer 1470. The breeder reactor is enclosed in a chamber 1485, which may be concrete and steel, to protect the reactor from external effects and to protect the environment from the reactor's radiation.

Such a breeder reactor can work in a neutron energy range between, for example, 0.1 and 1000 eV, in order to achieve adequate plutonium-239 or U-233 burning rates. Meanwhile, it is capable of converting U-238 or thorium-232 to fuel at the same rate in order to sustain the nuclear reaction.

If the concentration of plutonium-239 increases, for example, the reactor power increases. This situation may be offset by lowering the D-D fusion neutron yield by, for example, reducing the fusion fuelling rate. This will, in turn, decrease the neutron capture rate of U-238 and eventually bring the concentration of plutonium-239 back to normal. On the other hand, if the concentration of plutonium-239 becomes lower, the reactor power decreases. In this case, the fusion reaction rate can be increased in order to bring reactor power and the concentration of plutonium-239 back to normal.

As an alternative to a breeder reactor, it is also possible to split the nucleus of a U-238 atom by a fast neutron with energy exceeding 1 MeV. In order to incorporate this behavior, a hybrid fusion/fission reactor can be designed to work in the neutron energy range of 2-14 MeV.

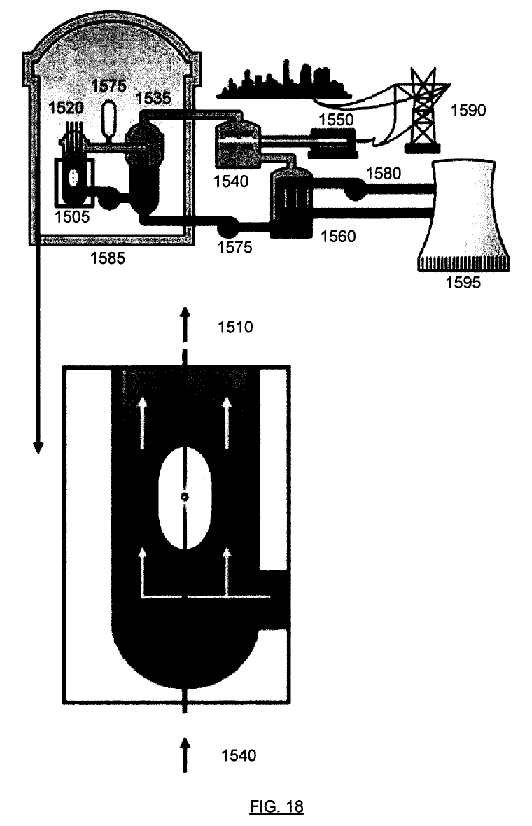

Referring now to FIG. 18, a possible hybrid fusion/fission reactor based on a modified PWR is illustrated. The hybrid fusion/fission reactor comprises reactor vessel 1505, control rods 1520, pressurizer 1575, steam generator 1535, turbine 1540, generator 1550, transmission tower 1590, condenser 1560, cooling tower 1595, and containment structure 1585.

In this example embodiment, a thermonuclear fusion reaction system (e.g. thermonuclear reaction system 100) is positioned in a reactor vessel 1505. The fusion chamber (e.g. reaction chamber 110) is preferably positioned at the center of the nuclear fuel for fission. In some embodiments, the nuclear power is primarily generated by fission, and the fission reactions are driven by fusion neutrons. The fusion chamber wall may be characterized as the interface between fission and fusion. Inside the fusion chamber wall, fusion reactions occur in a vacuum (or near-vacuum). Outside, the fusion chamber wall is cooled by the primary circulation system of the fission system. Control rods elements 1520 control the rate at which the fission takes place. A closed-loop circulation system (not shown) removes fusion products 1510 of the fusion reaction from the reactor vessel 1505. In addition to fusion products, un-burnt fuel to be recycled may also be removed from the fusion reactor (as the consumption of fuel particles is limited by the fusion reaction rate, it may not be possible to completely react all of the provided fusion fuel (e.g., D₂O, T₂O) in one circulation). The fusion products can be removed from, for example, gas collection tank 1270 in FIG. 13. As described above, the fusion products 1510 may comprise heavy water, tritium water, helium-3, helium-4, and regular water. The closed-loop system circulates heavy water and tritium water 1540 back into the reactor vessel 1505 for additional fusion reactions.

Pressurizer 1575 maintains a high pressure boundary for the primary heat transport system. A coolant in the primary heat transport system absorbs heat generated from the fusion/fission reaction. After absorbing heat generated from the fusion/fission reaction, the coolant in the primary heat transport system passes through the primary side of the steam generators 1535. Energy carried in the coolant is absorbed by liquid in the secondary side of the steam generators. The liquid in the secondary side of the steam generators boils and becomes steam. Steam output from the steam generators 1535 enters turbine 1540. Similar to the process in the breeder reactor, turbine 1540 is coupled to an electrical generator 1550. Steam passing through turbines 1540 causes turbine 1540 to spin and the electrical generator 1550 to rotate and generate electricity. Electricity from the electrical generator 1550 is transmitted to the electricity grid 1590.

Steam output from turbine 1540 enters condenser 1560. Condenser cooling pump 1580 pushes cold water from cooling tower 1595 to condenser 1560 where it absorbs heat from the steam. Cooled steam collects in condenser 1560 and becomes liquid. A water circulation pump 1575 pushes water from condenser 1560 back into the steam generator 1535 for further boiling and removal of heat from the reactor. The hybrid fusion/fission reactor is enclosed in a containment structure 1585 which protects the reactor from external effects and protects the environment from the reactor's radiation.

In the hybrid fusion/fission reactor, the U-238 fission rate (see e.g. 1010 in FIG. 13) for fast neutrons with energy >2 MeV can be optimized to match or exceed its absorption rate for thermal neutrons (observed to be significant enough to initiate plutonium-239 burning process in current nuclear power plants). For example, 1010 in FIG. 13 (e.g. the fission rate for U-238) increases with neutron energy, while 1020 (e.g. the neutron absorption rate for U-238) decreases with it. Therefore, this optimization may be achieved through the use of moderators such as water. Preferably, the use of moderators is minimized in order to maintain maximum neutron energy. For example, in a fusion/fission hybrid system (e.g. as shown in FIG. 18) that directly splits U-238 in a completely different neutron energy range, i.e., 2-14 MeV (which far exceeds the resonance domain of 10-1000 eV), we may consider D-T fusion reactions that can generate high-energy fusion neutrons (14.1 MeV).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative only and non-limiting.

### REFERENCES

Thonemann, P. C. et al. Controlled Release of Thermonuclear Energy—Production of High Temperatures and Nuclear Reactions in a Gas Discharge. Nature 181, 217-220 (1958).
Andrianov, A. M. et al. High-current Pulse Discharges. The 2nd United Nations

International Conference on the Peaceful Uses of Atomic Energy 31, 348-364 (1958).
McCracken, G. and Stott, P. Fusion—The Energy of the Universe, second edition, Elsevier 2005, reprinted in 2013.
Mosher, D. et al. X-radiation from high energy density exploded wire discharges. Appl. Phys. Lett. 23, 429-430 (1973).
Pereira, N. R. and Davis, J. X rays from z-pinches on relativistic electron beam generators. J Appl. Phys. 64, R1-27 (1988).
Zakharov, S., M. et al. Wire X-pinch in a high current diode. Sov. Tech. Phys. Lett. 8, 456-457 (1982).
Shelkovenko, T., A. et al. Evolution of the structure of the dense plasma near the cross point in exploding wire X pinches. Phys. Plasmas 6, 2840-2846 (1999).
Sinars, D. B. et al. Time-resolved spectroscopy of AL, Ti, and Mo X pinch radiation using an X-ray streak camera, J. Quantitative Spectroscopy & Radiative Transfer 78,61-83 (2003).
Burkhalter, P. et al. X-ray line spectra from exploded-wire arrays. J Appl. Phys. 50, 705-711 (1979).
Apruzese. J. P. et al. Comparative analysis of time-resolved and time-integrated X-ray data from long-pulse z-pinch implosions on Saturn. Phys. Plasmas 8, 3799-3809 (2001).
Haines, M. D. et al. Ion Viscous Heating in a Magnetohydrodynamically Unstable Z Pinch at Over 2×10⁹ Kelvin. Phys. Review Lett. 96(7), 24 February 2006.
Glenzer, S. H. et al. Cryogenic thermonuclear fuel implosions on the National Ignition Facility, Physics of Plasma 19(5), 31 May 2012.
Zheng, X. J. Continuous Fusion due to Energy Concentration Through Focusing of Converging Particle Beams. New U.S. Provisional Patent Application No. 61/495,481, Filing Date, Jun. 10, 2011.
Zheng, X. J. Continuous Fusion in Common Focal Region of Converging Fuel Lightning Bolts, [symbol] Chinese Patent Office, [symbol] , Application #201210211552.8, Jun. 21, 2012.
J. Christensen-Dalsgaard, et al., “The current state of solar modeling”, Science, Vol. 272, pp. 1286-1292, May 31, 1996.
Lawson, J. D. Some Criteria for a Power Producing Thermonuclear Reactor. Proc. Phys. Soc. 70, 6 (1957).
Clayton, D. D. Principles of Stellar Evolution and Nucleosynthesis. New York: McGraw-Hill 1968.
Burbidge, E. M. et al. Synthesis of the Elements in Stars. Review Modern Phys. 29, 547-650 (1957).
Adelberger, et al., “Solar fusion cross sections II—pp chain and CNO cycles”, Review of Modern Physics, Vol. 83, pp. 195-245, January-March 2011.
R. Feldbacher, “Nuclear Reaction Cross Sections and Reactivity Parameter Library and Files”, File # IAEA-NDS-86, Revision 0, October 1987.
Kalantar, D. H. An experimental study of the dynamics of X-pinch and z-pinch plasmas. Ph.D. Dissertation, Cornell University, 1993.
Williams, D. N. The Hydrogen Embrittlement of Titanium Alloys. J. Inst. Metals 91, 147-152 (1962).
Coleman, C. E. and Hardie, D. The hydrogen embrittlement of α-zirconium. J. Less-Common Metals, 168-185 (1966).
Grossbeck, M. L. and Birnbaum, H. K. Low Temperature Hydrogen Embrittlement of Niobium II—Microscopic Observations. Acta Met. 25, 135 (1977).
Takano, S. and Suzuki, T. An Electron-Optical Study of β-Hydride and Hydrogen Embrittlement of Vanadium. Acta Metall. 22, 265-274 (1974).
Perryman, E. C. Pickering pressure tube cracking experience. Nuclear Energy 17, 95-105 (1978).
Cann, C. D. and Sexton, E. E. An electron optical study of hydrides precipitation and growth at crack tips in zirconium. Acta Met. 28, 1215 (1980).
Simpson, L. A. and Cann, C. D. Fracture toughness of zirconium hydride and its influence on the crack resistance of zirconium alloys. J. Nucl. Mater. 87, 303-316 (1979).
Fu, Z. B., Qiu, L. H., Liu D. B., Li, B. and Yu, B., Fabrication and Characterization of Deuterated—Polystyrene Wire Used in Z-pinch Target. [symbol] , Chinese J. Atomic Energy Science & Tech. 39(6), 543-546 (2005).
M. Kikuchi, Frontiers in Fusion Research—Physics and Fusion, London/New York, Springer, 2010, reprinted in 2011.
Prialnik, Dina, An Introduction to the Theory of Stellar Structure and Evolution, Chapter 5, Cambridge University Press (2000).
Clayton, D. D. Principles of Stellar Evolution and Nucleosynthesis. New York: McGraw-Hill 1968.
Burbidge, E. M. et al. Synthesis of the Elements in Stars. Review Modern Phys. 29, 547-650 (1957).
Uman, M. A. Lightning, Dover Publications, Inc. New York 1984.
Deng, B. Q., “Fusion Reactor Physics-New Conception and New Technology”, Beijing, Chinese Atomic Energy Press, Chapter 15-19. P.129-166, October 2013.
Xiao Min (CGN), Status and Perspective of Spent Fuel Management and Fuel Cycle in China, WNA Plenary session, September 2013. (http://www.world-nuclear.org/info/Country-Profiles/Countries-A-F/China-Nuclear-Fuel-Cycle)

1. A system for generating a source of neutrons from a thermonuclear reaction, the system comprising:
a reaction chamber;
at least four particle beam emitters supported spatially around and oriented toward a common focal region of the reaction chamber for directing energized particles of at least one thermonuclear fuel type from the particle beam emitters as a plurality of particle beams converging symmetrically at the common focal region to instigate the thermonuclear reaction;
at least four particle beam receivers supported spatially around and oriented toward the common focal region, each particle beam receiver being located opposite a corresponding one of the at least four particle beam emitters; and
at least one voltage source operatively coupled to each particle beam emitter and its corresponding particle beam receiver for generating an electrical current through each particle beam.

2. The system of claim 1, wherein the at least four particle beam emitters are supported and oriented such that an angle between each particle beam is about 109.5°.

3. (canceled)

4. (canceled)

5. (canceled)

6. The system of claim 2, wherein the at least one of the at least four particle beam emitters further comprises an electromagnetic system for generating an electromagnetic field to provide radial confinement and axial acceleration of the energized particles in the high-energy plasma state within the particle beam tube.

7. The system of claim 6, wherein the electromagnetic system comprises a voltage supply electrically coupled to the particle beam tube and configured to generate a primary electrical current in an electrically conductive outer cylindrical portion of the particle beam tube running between the first end portion and the second end portion for generating a secondary electrical current flowing generally axially in the energized particles in the high-energy plasma state, the secondary electrical current for generating an inwardly directed radial force field within the electrically conductive outer cylindrical portion to urge the energized particles in the high-energy plasma state toward a central axis of the particle beam tube and to accelerate the energized particles in the high-energy plasma state toward the second end portion.

8. The system of claim 7, wherein the electromagnetic system further comprises a plurality of electromagnetic coils aligned axially with and supported exterior to and in close proximity surrounding the particle beam tube along at least a portion of particle beam tube, the plurality of electromagnetic coils for generating an axial magnetic field within the particle beam tube to provide supplemental axial confinement of the energized particles in the high-energy plasma state within the particle beam tube.

9. (canceled)

10. The system of claim 1, wherein an inner wall of the reaction chamber is coated with an inner wall layer substantially encompassing the inner wall and formed of a high-melting point material for providing the reaction chamber with thermal and gamma-ray insulation.

11. The system of claim 10, wherein the high-melting point material is selected from the group consisting of tungsten, graphite or tantalum hafnium carbide (Ta₄HfC₅).

12. (canceled)

13. (canceled)

14. The system of claim 1, wherein the at least four particle beam emitters are supported around the reaction chamber in a substantially spherical three-dimensional spatial orientation that is substantially symmetric in at least three mutually orthogonal planes.

15. (canceled)

16. (canceled)

17. (canceled)

18. The system of claim 1, wherein the at least one thermonuclear fuel type comprises an isotope of Hydrogen.

19. The system of claim 6, wherein the electromagnetic system and the at least one voltage source are configured to generate a plasma beam in a closed electric loop, the closed electrical loop running through the plasma beam and a plasma sphere located at the common focal region.

20. The system of claim 19, wherein the at least one voltage source is configured to supply a sufficiently high initial voltage to electrify particles of the at least one thermonuclear fuel type in the at least four particle beam emitters.

21. The system of claim 20, wherein the at least one voltage source is configured to subsequently reduce the initial voltage to a minimum maintenance voltage in order to supply a desired level of electrical current running through the plasma beam.

22. The system of claim 20, wherein the particles of the at least one thermonuclear fuel type are initially at a relatively low temperature in the at least four particle beam emitters, as the fuel particles enter the at least four particle beam emitters, and wherein the particles of the at least one thermonuclear fuel type in each of the at least four particle beam emitters are turned into plasma in the form of a lightning beam due to Joule heating by the generated electrical current after entering the at least four particle beam emitters.

23. The system of claim 22, wherein the at least one voltage source is configured to generate at least one sufficiently large DC, AC, or pulse current capable of pinching each of the plurality of particle beams into a continuous lightning beam, the continuous lightening beam having a level of electric current, a diameter, a velocity, and a temperature similar to these of a regular lightning beam in nature, whereby a hot and dense core forms inside the plasma sphere due to radial collapse under electro-magnetic fields, the core being capable of sustaining stable and continuous fusion reactions.

24. The system of claim 23, wherein the at least one voltage source is configured to generate a plurality of sufficiently large AC or pulse currents arranged to generate shock waves directed towards the common focal region to maximize an energy concentration at the plasma sphere.

25. The system of claim 1, further comprising a plurality of hollow starter inductors configured to establish initial boundary conditions for the plurality of particle beams so that the plurality of particle beams may each converge into a pinched configuration, wherein the at least one voltage source is configured to apply a voltage to the plurality of hollow starter inductors, and wherein the plurality of hollow starter inductors are configured to melt and/or vaporize due to Joule heating, starting from the common focal region, whereby the plurality of particle beams rapidly become electrically conducting lightning beams that collide and penetrate each other at the common focal region.

26. (canceled)

27. (canceled)

28. A method of generating a source of neutrons from a thermonuclear reaction, the method comprising:
providing at least one thermonuclear fuel type;
energizing a supply of the at least one thermonuclear fuel type to provide energized particles of the at least one thermonuclear fuel type;
accelerating the energized particles of the at least one thermonuclear fuel type into a reaction chamber as at least four particle beams oriented symmetrically toward a common focal region of the reaction chamber;
generating an electrical current through each of the at least four particle beams; and
converging the at least four particle beams at the common focal region to instigate the thermonuclear reaction.

29. The method of claim 28, wherein the at least four particle beam are generated using at least four particle beam emitters supported and oriented such that an angle between each particle beam is about 109.5°.

30. (canceled)

31. The method of claim 29, wherein at least some of the energized particles of the at least one thermonuclear fuel type are in a high-energy plasma state, and further comprising generating an electromagnetic field to provide radial confinement and axial acceleration of the energized particles in the high-energy plasma state into the reaction chamber.

32. The method of claim 31, wherein generating the electromagnetic field comprises inducing a secondary electrical current flowing in a generally axial direction through the energized particles in the high-energy plasma state and further comprises forming an axial magnetic field within the energized particles in the high-energy plasma state to provide supplemental radial confinement.

33. (canceled)

34. (canceled)

35. (canceled)

36. (canceled)

37. (canceled)

38. The method of claim 28, wherein the at least one thermonuclear fuel type comprises an isotope of Hydrogen.

39. The method of claim 29, further comprising generating a closed electric loop through each particle beam in the at least four particle beams, the closed electrical loop running through each plasma beam and a plasma sphere located at the common focal region.

40. The method of claim 29, wherein energizing the supply of the at least one thermonuclear fuel type comprises applying a sufficiently high initial voltage to electrify particles of the at least one thermonuclear fuel type.

41. The method of claim 40, further comprising subsequently reducing the initial voltage to a minimum maintenance voltage in order to supply a desired level of electrical current running through each of the at least four particle beams.

42. The method of claim 40, wherein the particles of the at least one thermonuclear fuel type are initially at a relatively low temperature as the fuel particles enter at least four particle beam emitters, and wherein the particles of the at least one thermonuclear fuel type in each of the at least four particle beam emitters are turned into plasma in the form of a lightning beam due to Joule heating by the generated electrical current after entering the at least four particle beam emitters.

43. The method of claim 42, wherein generating the electrical current through each of the at least four particle beams comprises generating at least one sufficiently large DC, AC, or pulse current capable of pinching each of the plurality of particle beams into a continuous lightning beam, the continuous lightening beam having a level of electric current, a diameter, a velocity, and a temperature similar to these of a regular lightning beam in nature, whereby a hot and dense core forms inside the plasma sphere due to radial collapse under electro-magnetic fields, the core being capable of sustaining stable and continuous fusion reactions.

44. The method of claim 43, wherein generating the electrical current through each of the at least four particle beams further comprises generating a plurality of sufficiently large AC or pulse currents arranged to generate shock waves directed towards the common focal region to maximize an energy concentration at the plasma sphere.

45. (canceled)

46. (canceled)
